(19) United States
(12) Patent Application Publication
(10) Pub. No.: US 2022/0342427 A1
(43) Pub. Date: Oct. 27, 2022

(54) INFORMATION PROCESSING DEVICE, INFORMATION PROCESSING METHOD, AND PROGRAM

(71) Applicant: SONY GROUP CORPORATION, TOKYO (JP)

(72) Inventors: TAKUTO MOTOYAMA, TOKYO (JP); MASAHIKO TOYOSHI, TOKYO (JP); SHUN LEE, TOKYO (JP); KOHEI URUSHIDO, TOKYO (JP)

(21) Appl. No.: 17/764,812

(22) PCT Filed: Sep. 28, 2020
(86) PCT No.: PCT/JP2020/036520

§ 371 Date: Mar. 29, 2022

(30) Foreign Application Priority Data
Oct. 10, 2019 (JP) 2019-186747

(51) Int. Cl. G05D 1/10; G06T 7/73; G06T 17/20; G06T 7/521; G06T 7/593

(52) U.S. Cl. CPC G05D 1/106; G06T 7/73; G06T 17/20; G06T 7/521; G06T 7/593

(57) ABSTRACT

The present disclosure relates to an information processing device, an information processing method, and a program that cause a high-speed moving body to appropriately plan a trajectory. A position and distance of an object can be appropriately recognized by extracting feature points in association with a semantic label that is an object certification result by semantic segmentation, connecting feature points of the same semantic label, and forming a Delaunay mesh to form a mesh for each same object, and then a trajectory is planned. The present disclosure can be applied to a moving body.

### TECHNICAL FIELD

The present disclosure relates to an information processing device, an information processing method, and a program, and particularly relates to an information processing device, an information processing method, and a program capable of appropriately planning an obstacle avoidable trajectory when planning a trajectory serving as a movement path of a high-speed moving body.

### BACKGROUND ART

An autonomous moving body plans a trajectory to avoid surrounding obstacles when planning a trajectory serving as a movement path toward a destination.

As a method of planning such a trajectory, there is proposed a technology of detecting a surrounding situation, generating, for example, an occupancy grid map, identifying positions of obstacles, and planning a trajectory to avoid the obstacles (see Patent Document 1).

### CITATION LIST

### Patent Document

Patent Document 1: Japanese Patent Application Laid-Open No. 2005-092820

### SUMMARY OF THE INVENTION

### Problems to be Solved by the Invention

However, the occupancy grid map is generated on the premise of convolution in a time direction, and therefore it takes time to converge occupation probability until a position of a surrounding obstacle is identified.

Therefore, a low-speed autonomous moving body can appropriately plan a trajectory to avoid obstacles, but a high-speed autonomous moving body cannot appropriately plan a trajectory to avoid obstacles in some cases because the occupation probability of the occupancy grid map cannot converge in time.

The present disclosure has been made in view of such a circumstance, and, in particular, an object thereof is to cause a high-speed moving body to appropriately plan a trajectory as a movement path to avoid obstacles.

### Solutions to Problems

An information processing device and a program according to one aspect of the present disclosure are an information processing device and a program including: an object recognition unit that recognizes an object in an image of surroundings of a moving body; a feature point extraction unit that extracts feature points from the image in association with an object recognition result by the object recognition unit; a mesh creation unit that creates a mesh representing an obstacle by connecting the feature points for each same object on the basis of the object recognition result; and an action planning unit that plans action of the moving body to avoid the obstacle on the basis of the mesh created by the mesh creation unit.

An information processing method according to one aspect of the present disclosure is an information processing method including the steps of: recognizing an object in an image of surroundings of a moving body; extracting feature points from the image in association with a recognition result of the object; creating a mesh representing an obstacle by connecting the feature points for each same object on the basis of the recognition result of the object; and planning action of the moving body to avoid the obstacle on the basis of the created mesh.

In one aspect of the present disclosure, an object in an image of surroundings of a moving body is recognized, feature points are extracted from the image in association with an object recognition result, the feature points are connected for each same object on the basis of the object recognition result to create a mesh representing an obstacle, and action of the moving body to avoid the obstacle is planned on the basis of the created mesh.

### BRIEF DESCRIPTION OF DRAWINGS

FIG. 1 illustrates a trajectory plan using a Delaunay mesh.

FIG. 2 illustrates an example where a trajectory is not appropriately planned in a trajectory plan using a Delaunay mesh.

FIG. 3 illustrates an example where a trajectory is not appropriately planned in a trajectory plan using a Delaunay mesh.

FIG. 4 illustrates an example where a trajectory is not appropriately planned in a trajectory plan using a Delaunay mesh.

FIG. 5 illustrates an example where a trajectory is not appropriately planned in a trajectory plan using a Delaunay mesh.

FIG. 6 illustrates an outline of the present disclosure.

FIG. 7 is a block diagram illustrating a configuration example of a first embodiment of a moving body of the present disclosure.

FIG. 8 is a block diagram illustrating a configuration example of a trajectory planning unit of FIG. 7.

FIG. 9 illustrates semantic segmentation.

FIG. 10 illustrates conversion of a coordinate system of a depth image detected by a depth sensor into a coordinate system of an image captured by a camera.

FIG. 11 illustrates a method of extracting feature points.

FIG. 12 illustrates a method of generating a two-dimensional Delaunay mesh.

FIG. 13 illustrates a method of converting a two-dimensional Delaunay mesh into a three-dimensional Delaunay mesh.

FIG. 14 illustrates a method of selecting a trajectory candidate.

FIG. 15 illustrates a margin that is set in accordance with a semantic label of an obstacle.

FIG. 16 illustrates a method of calculating an evaluation value of a distance.

FIG. 17 is a flowchart showing trajectory planning processing by the trajectory planning unit of FIG. 8.

FIG. 18 is a block diagram illustrating a configuration example of a second embodiment of the moving body of the present disclosure.

FIG. 19 is a block diagram illustrating a configuration example of a trajectory planning unit of FIG. 18.

FIG. 20 is a block diagram illustrating a configuration example of a depth reliability filtering unit of FIG. 19.

FIG. 21 is a flowchart showing trajectory planning processing by the trajectory planning unit of FIG. 19.

FIG. 22 is a flowchart showing a filtering processing by the depth reliability filtering unit of FIG. 20.

FIG. 23 illustrates an outline of a third embodiment in which a normal direction is estimated on the basis of a polarized image captured by a polarization camera and feature points are extracted on the basis of the normal direction.

FIG. 24 is a block diagram illustrating a configuration example of the third embodiment of the moving body of the present disclosure.

FIG. 25 is a block diagram illustrating a configuration example of a trajectory planning unit of FIG. 24.

FIG. 26 is a flowchart showing trajectory planning processing by the trajectory planning unit of FIG. 25.

FIG. 27 illustrates a configuration example of a general-purpose computer.

### MODE FOR CARRYING OUT THE INVENTION

Hereinafter, preferred embodiments of the present disclosure will be described in detail with reference to the accompanying drawings. Note that, in this specification and the drawings, components having substantially the same functional configurations will be represented as the same reference signs, and repeated description thereof will be omitted.

Hereinafter, modes for carrying out the present technology will be described. Description will be provided in the following order.

1. Outline of present disclosure

2. First Embodiment

3. Second Embodiment

4. Third Embodiment

5. Example of execution by software

### 1. Outline of Present Disclosure

The present disclosure enables even a high-speed autonomous moving body to appropriately plan a trajectory as a movement path to avoid obstacles in accordance with a surrounding situation.

First, an outline of the present disclosure will be described.

In planning a trajectory as a movement path of a moving body, generally, an occupancy grid map is generated, then positions and distances of surrounding obstacles are identified, and a trajectory is planned in accordance with the positions and distances of the obstacles.

However, the occupancy grid map is formed on the premise of convolution in a time direction, and thus it takes time to form the occupancy grid map.

Therefore, a high-speed autonomous moving body cannot appropriately plan a trajectory to avoid obstacles in some cases because the occupancy grid map cannot be formed in time.

In view of this, there is proposed a technology of, on the basis of an image of surroundings, extracting feature points from the image, forming a mesh of triangular surfaces having the feature points as vertices, recognizing obstacles represented by the formed mesh, and planning a trajectory to avoid the recognized obstacles.

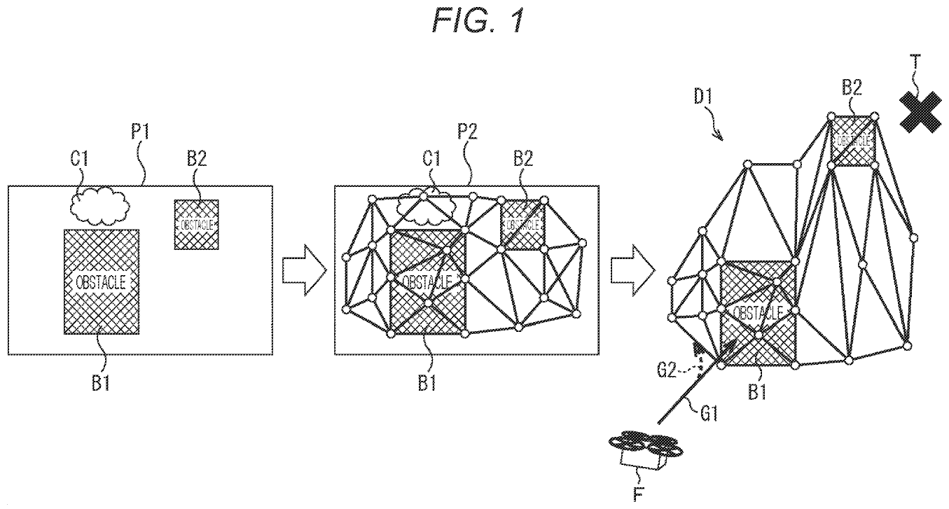

More specifically, there will be described a case where, for example, an image in which a sky Cl with a cloud and obstacles B1 and B2 appear is captured as illustrated in an image P1 of FIG. 1 (left part of FIG. 1) and a depth image (distance image) at a corresponding angle of view is detected.

Further, feature points are extracted from such an image P1 as indicated by, for example, circle marks in an image P2.

First, the obstacles are represented by a two-dimensional Delaunay mesh by forming triangular surfaces having the feature points indicated by the circle marks in the image P2 (center part of FIG. 1) as vertices.

Then, the obstacles represented by the two-dimensional Delaunay mesh are three-dimensionalized on the basis of depth information (distance information) of pixels of the depth image at the feature points and therefore are represented by a three-dimensional Delaunay mesh D1 (right part of FIG. 1), and then a trajectory of a moving body F that can move toward a destination T is planned to avoid the obstacles.

As illustrated in FIG. 1, for example, in a case where the moving body F attempts to autonomously move toward the destination T indicated by an X mark and there is no obstacle represented by the three-dimensional Delaunay mesh D1, a trajectory G1 is planned. Meanwhile, when the obstacles represented by the three-dimensional Delaunay mesh D1 are recognized, for example, a trajectory G2 indicated by a dotted line is planned to avoid the recognized obstacles, instead of the trajectory G1.

As a result, a trajectory including a movement path to avoid the obstacles is planned as a trajectory for the moving body to reach the destination.

As described above, a trajectory to avoid the obstacles can be planned by representing the obstacles with the three-dimensional Delaunay mesh D1 only by using the depth information at the feature points in the information of the image P1. This makes it possible to plan a trajectory at a high speed with a smaller amount of information (with lower latency) than forming an occupancy grid map.

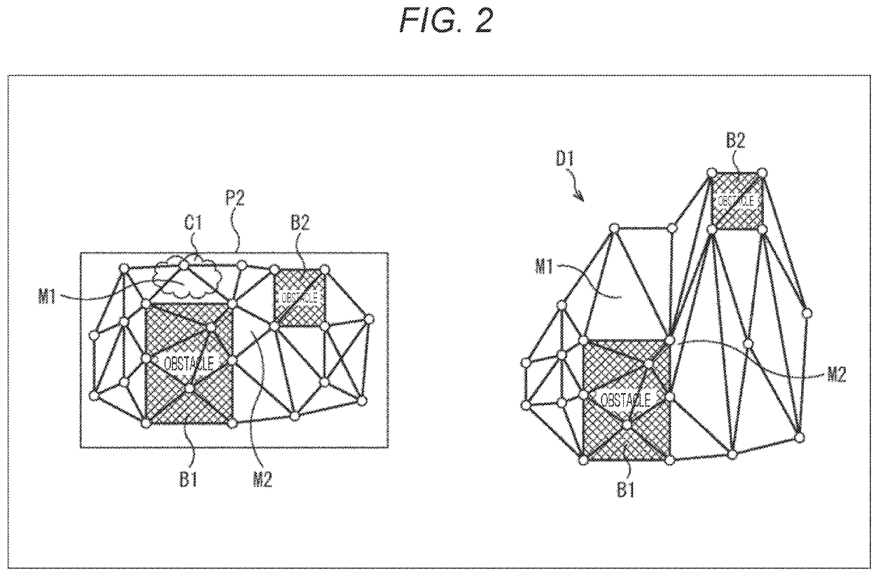

However, in the three-dimensional Delaunay mesh formed as described above, as illustrated in the image P2 and the three-dimensional Delaunay mesh D1 of FIG. 2, for example, surfaces M1 and M2 are formed in a region where the obstacles B1 and B2 do not originally exist, and thus information is formed as if an obstacle to be avoided exists.

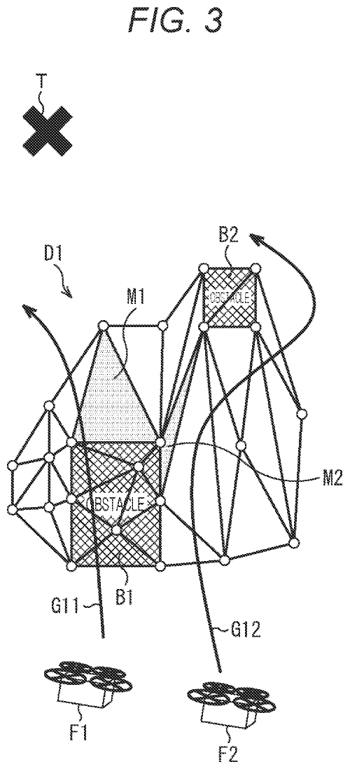

Therefore, as illustrated in FIG. 3, although a moving body F1 can pass over the obstacle B1, a detour trajectory G11 is planned to avoid the surface M1 because the surface M1 is recognized as an obstacle.

Further, similarly, as illustrated in FIG. 3, although a moving body F2 can originally pass between the obstacles B1 and B2, a detour trajectory G12 may be planned to avoid the surface M2 between the obstacles B1 and B2 because the surface M2 is recognized as an obstacle.

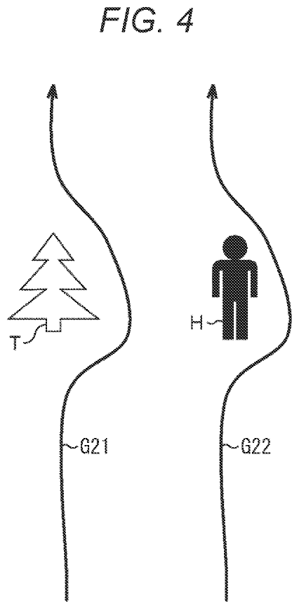

Furthermore, in planning a trajectory using a Delaunay mesh, the trajectory is planned only on the basis of presence or absence of obstacles. Therefore, for example, as illustrated in a left part of FIG. 4, a trajectory G21 for avoiding an obstacle such as a tree T that does not move and is hardly affected even when in contact with the moving body by any chance and a trajectory G22 for avoiding an obstacle such as a human H who may move and must not be in contact with the moving body are planned to have the same distance from the obstacles.

That is, a moving body 11 may not be able to move along an assumed trajectory due to an influence of wind, rain, or the like, and, if the moving body significantly deviates from the trajectory, the moving body may come into contact with the obstacles.

Therefore, in planning a trajectory, in a case where, for example, the tree T or the like that is hardly affected even when in contact with the moving body is an obstacle to be avoided, the trajectory may be planned at a position having a relatively short distance from the obstacle, but, in a case where the obstacle to be avoided is the human H or the like who is greatly affected when in contact with the moving body, it is desirable to plan the trajectory at a relatively distant position.

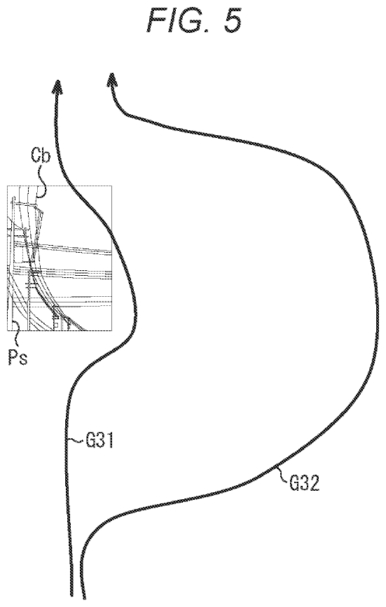

Further, as illustrated in FIG. 5, in a case where a utility pole Ps is recognized and a trajectory G31 for avoiding the utility pole Ps is planned because the utility pole is recognized as an obstacle, the moving body may come into contact with electric wires Cb or the like that may exist in the vicinity of the utility pole Ps and are hardly recognized from an image. Therefore, it is desirable to plan, for example, a trajectory G32 or the like having a larger margin than a predetermined margin (at a position farther than a predetermined distance) from the utility pole Ps in consideration of a range in which existence of the electric wires Cb is estimated from the utility pole Ps recognized in the image.

That is, in a case where a trajectory is planned only in consideration of an obstacle represented by a three-dimensional Delaunay mesh, there is a possibility that the trajectory is planned without considering a distance from the obstacle in accordance with the type of obstacle. Therefore, an appropriate trajectory may not always be planned, and, as a result, a dangerous state may be caused as the moving body moves.

In view of this, the present disclosure performs object recognition processing on a captured image, forms a two-dimensional Delaunay mesh for feature points within a range in which the same type of object exists in accordance with a recognition result, then three-dimensionalizes the two-dimensional Delaunay mesh by using depth information to thereby represent an obstacle, and plans a trajectory.

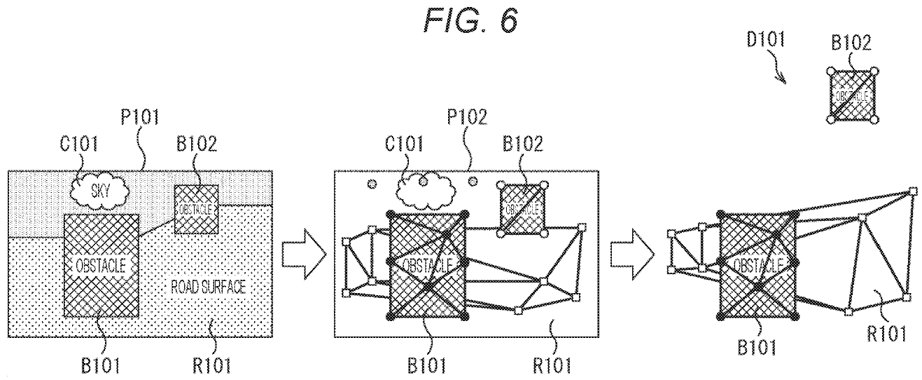

As a more specific case, there will be described a case where an image P101 of FIG. 6 in which a sky C101, obstacles B101 and B102, and a road surface R101 exist is captured and a depth image at the same angle of view is detected.

In this case, regions of the sky C101, the obstacles B101 and B102, and the road surface R101 in the image are recognized by the object recognition processing based on the image P101.

Further, as illustrated in an image P102, feature points are extracted from the image P101.

Further, as illustrated in the image P102, a two-dimensional Delaunay mesh is formed by connecting feature points in each of the regions of the objects recognized by the object recognition processing, that is, in each of the regions of the obstacles B101 and B102 and the road surface R101.

At this time, feature points in the vicinity of the region of the sky C101 are not extracted because the sky cannot be an obstacle, thereby preventing a Delaunay mesh from being formed. In other words, only feature points existing in the vicinity of a region that can be an obstacle are connected for each type of obstacle to form a Delaunay mesh.

Then, on the basis of the depth image, a three-dimensional Delaunay mesh D101 is generated for each object, i.e., for each of the obstacles B101 and B102 and the road surface R101.

As described above, the feature points are connected for each type of recognized object to form a Delaunay mesh, and then the three-dimensional Delaunay mesh D101 is formed. Therefore, no mesh is formed in a space where no object exists. This makes it possible to appropriately plan a trajectory to avoid obstacles.

At this time, it is possible to recognize positions of the obstacles by processing only using feature points, instead of processing performed on the premise of convolution in a time direction such as an occupancy grid map. This makes it possible to accurately recognize the positions of the obstacles and plan a trajectory while reducing a processing load. Therefore, even a trajectory of a high-speed autonomous moving body can be appropriately planned.

Further, because the type of obstacle can be recognized, it is possible to plan a trajectory in consideration of a distance from the obstacle in accordance with the type of obstacle. This makes it possible to plan a trajectory as a movement path while ensuring safety based on the type of obstacle.

### 2. First Embodiment

<Configuration Example of Moving Body>

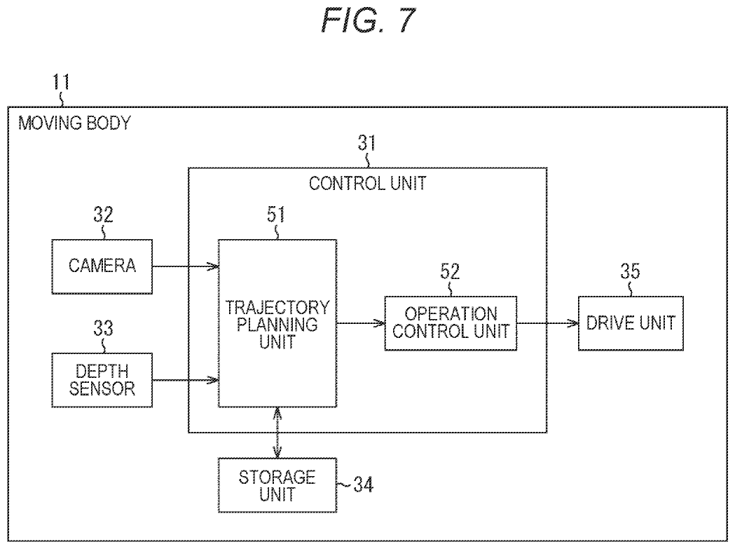

Next, a configuration example of a moving body represented by a drone or the like to which the technology of the present disclosure is applied will be described with reference to the block diagram of FIG. 7.

Note that examples where the moving body is a drone will be described in this specification, but the moving body can be any movable object such as a vehicle, flying object, ship, or robot.

The moving body 11 of FIG. 7 includes a control unit 31, a camera 32, a depth sensor 33, a storage unit 34, and a drive unit 35.

The control unit 31 includes a processor and a memory, reads a predetermined program or data stored in the storage unit 34 or the like, executes various kinds of processing, and controls the entire operation of the moving body 11.

Further, the control unit 31 includes a trajectory planning unit 51 and an operation control unit 52.

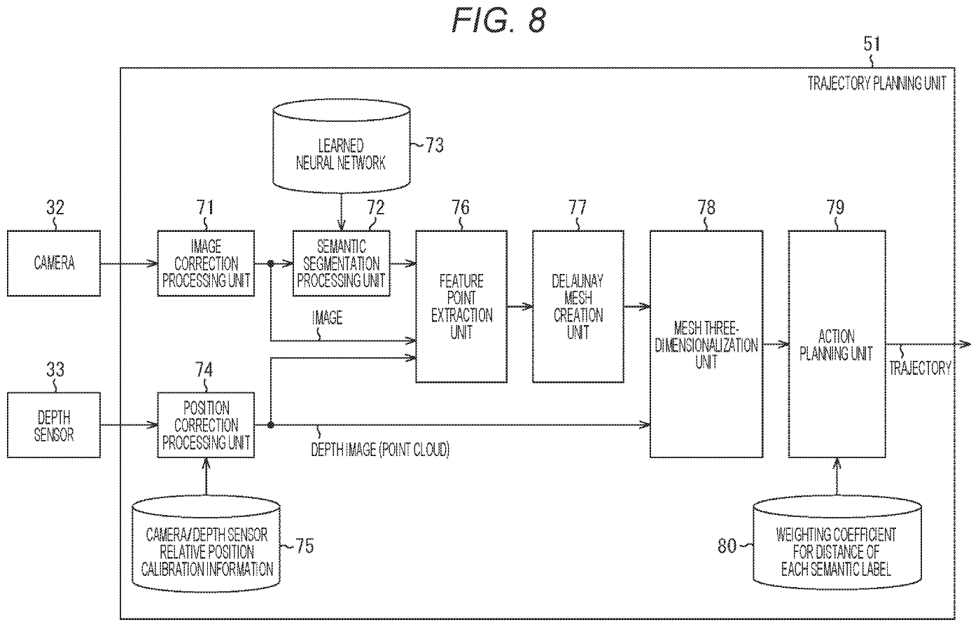

The trajectory planning unit 51 plans a movement path of the moving body 11 as a trajectory on the basis of an image (RGB image) captured by the camera 32 and a depth image (point cloud) detected by the depth sensor 33 and outputs the planned trajectory to the operation control unit 52. Note that a detailed configuration of the trajectory planning unit 51 will be described later in detail with reference to FIG. 8.

The operation control unit 52 controls the drive unit 35 on the basis of information on the trajectory serving as the movement path of the moving body 11 supplied from the trajectory planning unit 51, thereby moving the moving body 11 along the planned trajectory.

The camera 32 includes, for example, an image sensor such as a charge coupled device (CCD) or a complementary metal oxide semiconductor (CMOS), captures an image (RGB image) of surroundings of the moving body 11, and outputs the captured image to the trajectory planning unit 51 of the control unit 31.

The depth sensor 33 includes, for example, light detection and ranging or laser imaging detection and ranging (LiDAR) or a stereo camera, detects a depth image (point cloud) within a range corresponding to an angle of view of the camera 32, and outputs the detected depth image to the trajectory planning unit 51 of the control unit 31. Note that description will be made on the assumption that the depth sensor 33 is LiDAR in the first embodiment.

The storage unit 34 includes, for example, a hard disc drive (HDD), solid state drive (SSD), or the like and is controlled by the control unit 31 to store various programs and data and supply the programs and data.

The drive unit 35 includes a drive mechanism such as various actuators and motors necessary for flight of the moving body 11 such as a drone and is controlled by the operation control unit 52 to operate to move along the trajectory serving as the planned movement path.

Note that, in a case where the moving body 11 is a drone, the drive unit 35 includes a drive mechanism required for flight, but, in a case of a vehicle, the drive unit 35 includes a drive mechanism necessary for traveling, in a case of a ship, the drive unit 35 includes a drive mechanism necessary for navigation, and, in a case of a robot, the drive unit 35 includes a drive mechanism necessary for walking or running. In addition, the drive unit 35 includes a drive mechanism according to a form of the moving body 11.

<Configuration Example of Trajectory Planning Unit>

Next, a configuration example of the trajectory planning unit 51 will be described with reference to a block diagram of FIG. 8.

The trajectory planning unit 51 includes an image correction processing unit 71, a semantic segmentation processing unit 72, a storage unit 73, a position correction processing unit 74, a storage unit 75, a feature point extraction unit 76, a Delaunay mesh creation unit 77, and a mesh three-dimensionalization unit 78, an action planning unit 79, and a storage unit 80.

The image correction processing unit 71 performs general image correction processing such as removal of distortion caused by a lens included in the camera 32, demosaic processing, and gamma correction processing on the image captured by the camera 32 and outputs the corrected image to the semantic segmentation processing unit 72 and the feature point extraction unit 76.

Note that the processing performed by the image correction processing unit 71 is desirably the same as processing used for specific semantic segmentation learning in the semantic segmentation processing unit 72, and recognition accuracy can be improved as the processing performed by the image correction processing unit 71 is closer to the processing used for the learning.

The semantic segmentation processing unit 72 classifies types of subjects on a pixel basis by semantic segmentation on the basis of the RGB image captured by the camera 32 by using, for example, a learned neural network stored by learning in advance in the storage unit 73.

Then, the semantic segmentation processing unit 72 divides the image into regions of the same type, attaches a semantic label corresponding to a division result as a processing result of the semantic segmentation, and outputs the semantic label to the feature point extraction unit 76.

Note that, in the semantic segmentation, for example, a black-and-white image may be used instead of the RGB image. Further, instance segmentation of further dividing a region of the same type into regions of objects may be performed.

Further, the storage unit 73 may be formed by, for example, a partial region of the storage unit 34 of FIG. 7 or may be separately formed.

The position correction processing unit 74 converts a coordinate system of the depth image (point cloud) supplied from the depth sensor 33 into a coordinate system of the image captured by the camera 32 so as to perform position correction on the basis of camera/depth sensor relative position calibration information stored in advance in the storage unit 75 and generates a depth image (point cloud) having a coordinate system corresponding to the image captured by the camera 32.

Therefore, the coordinate system of each pixel of the depth image (point cloud) detected by the depth sensor 33 is converted into the coordinate system of the image captured by the camera 32, and a depth image (point cloud) on which distance information is superimposed is generated at a position corresponding to a pixel of the RGB image captured by the camera 32 and is then output to the feature point extraction unit 76 and the mesh three-dimensionalization unit 78.

Further, the storage unit 75 may be formed by, for example, a partial region of the storage unit 34 of FIG. 7 or may be separately formed.

The feature point extraction unit 76 extracts feature points serving as vertices of triangles forming a two-dimensional Delaunay mesh on the basis of the RGB image supplied from the image correction processing unit 71, the processing result of the semantic segmentation supplied from the semantic segmentation processing unit 72, and the depth image (point cloud) superimposed on the RGB image and outputs the extracted feature points to the Delaunay mesh creation unit 77.

At this time, the feature point extraction unit 76 attaches a corresponding semantic label to each feature point.

Herein, the feature points used herein may be, for example, pixel positions having depth information in the depth image converted into the coordinate system of the camera 32.

That is, herein, the depth sensor 33 is the LiDAR, and a density of pixels having depth information detected by the LiDAR is less than a density of pixels in the image captured by the camera 32, and therefore the pixel positions may be used as they are as the feature points.

Note that, hereinafter, description will be made on the assumption that the feature point extraction unit 76 extracts, as feature points, information regarding pixel positions having depth information in a depth image. However, feature points in other conditions may be extracted.

The Delaunay mesh creation unit 77 forms triangular surfaces having the feature points as vertices on the basis of the feature points supplied from the feature point extraction unit 76, creates a two-dimensional Delaunay mesh in the image, and outputs the two-dimensional Delaunay mesh to the mesh three-dimensionalization unit 78.

At this time, the Delaunay mesh creation unit 77 forms triangular surfaces having feature points to which the same semantic label is attached as vertices to create a two-dimensional Delaunay mesh.

The mesh three-dimensionalization unit 78 three-dimensionalizes the two-dimensional Delaunay mesh on the basis of the two-dimensional Delaunay mesh supplied from the Delaunay mesh creation unit 77 and the depth image (point cloud) supplied from the position correction processing unit 74, generates a three-dimensional Delaunay mesh, and outputs the three-dimensional Delaunay mesh to the action planning unit 79.

At this time, the mesh three-dimensionalization unit 78 three-dimensionalizes the two-dimensional Delaunay mesh in which the triangular surfaces having the feature points to which the same semantic label is attached as the vertices are connected on the basis of the depth information (distance information) of the corresponding depth image (point cloud) and outputs a three-dimensional Delaunay mesh to the action planning unit 79. Note that, in a case where a length of one side of the triangle is extremely long in a three-dimensional distance, a triangle having the extremely long side may be removed from the mesh at this time.

The action planning unit 79 plans a trajectory as a movement path of the moving body 11 on the basis of the three-dimensional Delaunay mesh supplied from the mesh three-dimensionalization unit 78 and outputs the planned trajectory to the operation control unit 52.

At this time, the action planning unit 79 sets a distance from the obstacle by using a weighting coefficient for a distance of each semantic label stored in the storage unit 80 and plans the trajectory as the movement path of the moving body 11.

Further, the storage unit 80 may be formed by, for example, a partial region of the storage unit 34 of FIG. 7 or may be separately formed.

<Semantic Segmentation>

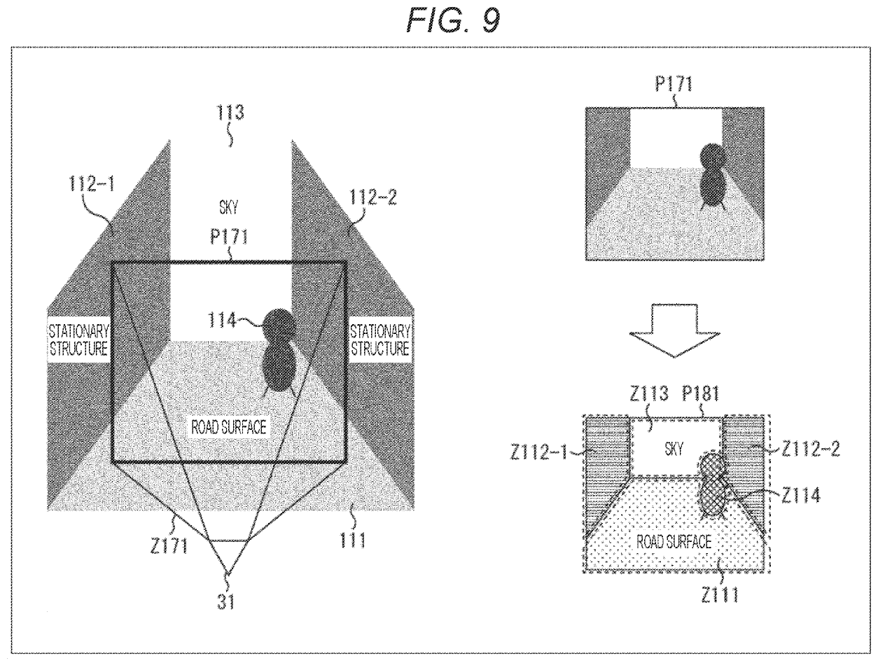

Next, the semantic segmentation by the semantic segmentation processing unit 72 will be described with reference to FIG. 9.

For example, as illustrated in a left part of FIG. 9, the camera 32 captures an image P171 formed by an RGB image at an angle of view 2171 of a composition in which a road surface 111 exists in a space between left and right stationary structures 112-1 and 112-2, a person 114 exists on the road surface 111, and a sky 113 can be seen behind the person.

The semantic segmentation processing unit 72 reads and uses a neural network learned in advance by machine learning such as deep learning and stored in the storage unit 73, classifies the types of subjects in the image P171 on a pixel basis on the basis of the image P171 formed by the RGB image as illustrated in an upper right part of FIG. 9, and labels the types as semantic labels.

In a case of the image P171 formed by the RGB image illustrated in the upper right part of FIG. 9, for example, the types of objects are classified by the semantic segmentation, and semantic labels are labeled on the basis of a classification result as illustrated in a labeling image P181 in a lower right part of FIG. 9.

That is, in the labeling image P181, pixels belonging to a region 2111 in a lower part of the image are classified as the road surface 111, pixels belonging to regions Z112-1 and Z112-2 are classified as the left and right stationary structures 112-1 and 112-2, respectively, pixels belonging to a region 2113 are classified as the sky 113 on the back side, and pixels belonging to a region 2114 are classified as the person 114.

In addition to the example of FIG. 9, on the basis of an RGB image and a distance image, the semantic segmentation processing unit 72 identifies, for example, road surfaces, stationary structures (wall, guard rail, tree, utility pole, and the like), vehicles (automobile, truck, bus, and the like), two-wheeled vehicles (motorcycle and bicycle), people, horizontal bars (crossing bar, ETC bar, and parking gate bar), and the sky in the RGB image on a pixel basis and labels the above objects.

Note that the semantic segmentation can classify subjects by machine learning by using only an RGB image, only a depth image, or a combination of both and therefore may be achieved by any thereof.

<Superimposition of Depth Image Serving as Measurement Result by Depth Sensor on Image Captured by Camera>

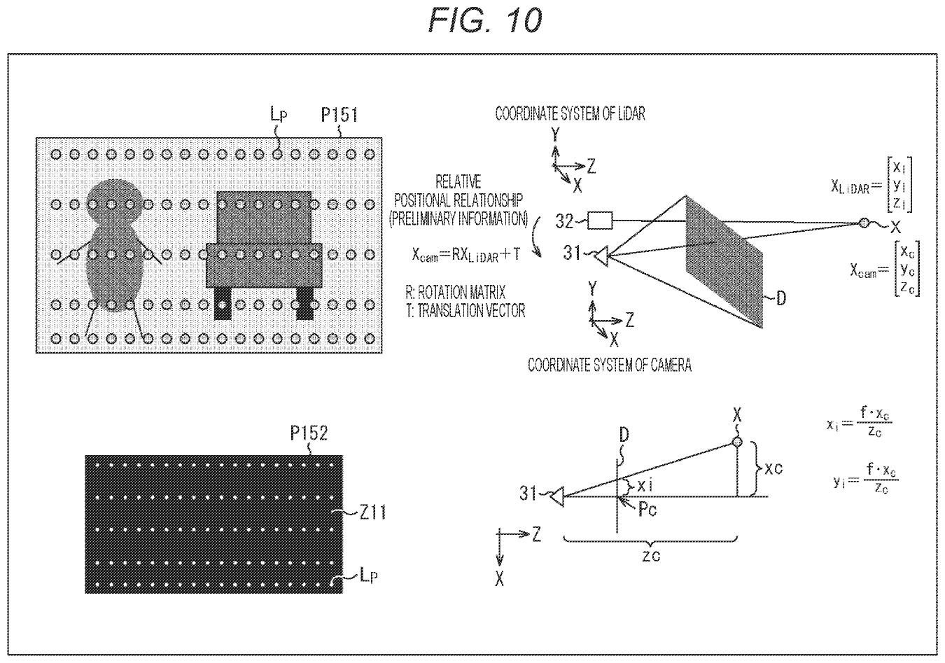

Next, processing in which the position correction processing unit 74 superimposes each pixel of a depth image (point cloud) having information regarding a set of points in a three-dimensional space measured by the depth sensor 33 including LiDAR, a stereo camera, or the like on a pixel of a coordinate system of an image captured by the camera 32 and generates a depth image will be described with reference to FIG. 10.

Note that, herein, description will be made on the assumption that the depth sensor 33 is the LiDAR, but similar description will be made on the assumption that the depth sensor 33 is a stereo camera or the like.

For example, a distance image (depth image) is generated by superimposing a ranging result in each light projection direction Lₚ of LiDAR 33 on an image P151 of the camera 32 illustrated in an upper left part of FIG. 10.

Information regarding a relative position between the LiDAR 33 and the camera 32 and an image center and a focal length of the camera 302 is stored in the storage unit 75 in advance as the camera/depth sensor relative position calibration information (preliminary information) by preliminary calibration. Therefore, the position correction processing unit 74 uses the camera/depth sensor relative position calibration information stored in the storage unit 75 to generate a depth image by the following calculation.

First, the position correction processing unit 74 integrates a coordinate system of the depth sensor 33 including the LiDAR into a coordinate system of the camera 32.

That is, as illustrated in an upper right part of FIG. 10, a relative positional relationship between coordinates X_{LiDAR} (=transposed matrix of [x₁, y₁, z₁]) serving as the coordinate system of the depth sensor 33 including the LiDAR and coordinates X_{cam} (=transposed matrix of [x_{c}, y_{c}, z_{c}]) of the coordinate system of the camera 302 on an image capturing surface D is known by calibration as the preliminary information and is obtained from, for example, the following Expression (1).

X_{cam}=RX_{LiDAR}+T (1)

Herein, R denotes a rotation matrix indicating rotation between the depth sensor 33 including the LiDAR and the camera 32, which is known in advance by calibration, and T denotes a translation vector that is also known in advance by calibration.

By calculating the above Expression (1), coordinates of a point X that is the ranging result measured as the information regarding the coordinate system of the depth sensor 33 including the LiDAR are converted into a coordinate system of the camera.

Next, the position correction processing unit 74 associates the ranging result by the LiDAR 33 with the coordinate system of the camera 32 on the image capturing surface.

That is, when the coordinates X_{cam} (=[x_{c}, y_{c}, z_{c}] transposition) of an obstacle detected by the depth sensor 33 including the LiDAR is obtained, as illustrated in a lower right part of FIG. 10, xᵢ coordinates of the obstacle on the image capturing surface D on an image plane based on an image center Pc of the image capturing surface D can be obtained from the following Expression (2).

xᵢ=f×x_{c}/z_{c} (2)

Herein, f denotes the focal length of the camera 32.

Further, similarly, yᵢ coordinates can be obtained from the following Expression (3).

yᵢ=f×y_{c}/z_{c} (3)

As a result, a position of the obstacle on the image capturing surface D can be identified.

That is, the coordinates X_{LiDAR} (=[xₗ, yₗ, zₗ]) of a three-dimensional point detected by the depth sensor 33 including the LiDAR is converted into the coordinates X_{cam} (=[x_{c}, y_{c}, z_{c}]) of a three-dimensional point in the coordinate system of the camera 32 on the basis of the light projection direction. Further, coordinates (xᵢ, yᵢ) on an image capturing surface centered on the image capturing surface D corresponding to the coordinates X_{cam} (=[x_{c}, y_{c}, z_{c}]) of the three-dimensional point in the coordinate system of the camera 32 are calculated from Expressions (2) and (3) on the basis of the focal length f of the camera 32.

By this processing, the position correction processing unit 74 generates a distance image P152 as illustrated in a lower left part of FIG. 10.

The distance image P152 has the same pixel arrangement as the image of the camera 32. Because of the conversion of the coordinate systems described above, in a case where, among all the pixels (xᵢ, yᵢ), pixels are in the light projection direction of the LiDAR 33 and have a ranging result, distance data (z_{c} in the lower right part of FIG. 10) is stored in association with each pixel, whereas, in a case where pixels are not in the light projection direction or have no ranging result, for example, 0 is stored as the distance data.

<Extraction of Feature Points>

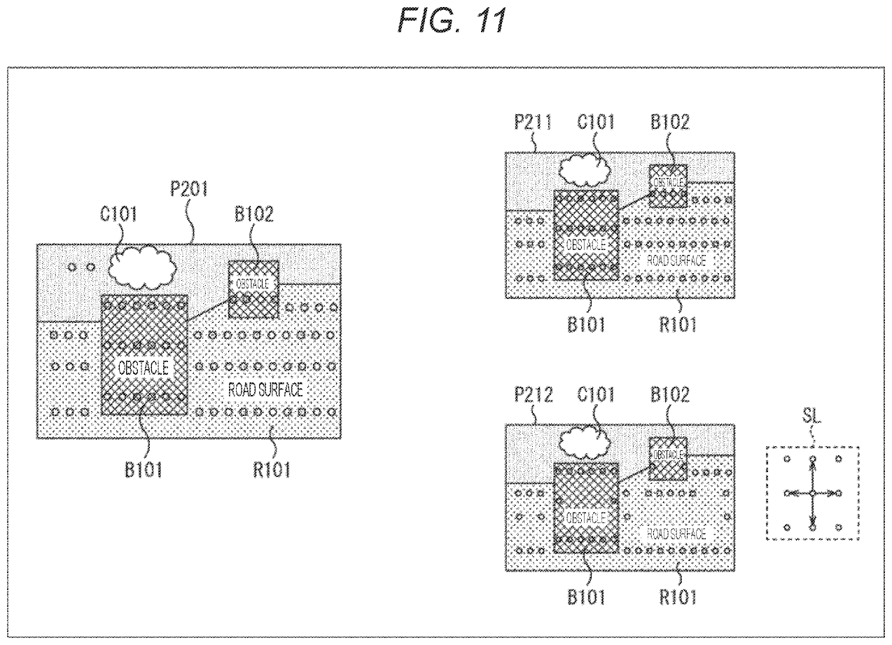

Next, a method of extracting feature points in the feature point extraction unit 76 will be described with reference to FIG. 11.

For example, an image P201 in which the obstacles B101 and B102 exist on the road surface R101 and the sky C101 is above the obstacles as illustrated in a left part of FIG. 11 will be described.

The ranging result in each light projection direction Lₚ by the LiDAR 33 in FIG. 10 is superimposed on each position indicated by a circle mark in the image P201.

As illustrated in an upper right part of FIG. 11, for example, among semantic labels of the circle marks each including the ranging result in each light projection direction Lₚ by the LiDAR 33, the feature point extraction unit 76 labels, with semantic labels, points with circle marks other than those of the sky C101 that cannot be an obstacle and extracts the points as feature points.

As described above, because only the feature points labeled with the semantic label that can be an obstacle when the moving body 11 moves are extracted, it is possible to form a Delaunay mesh in a region where an object to be recognized as an obstacle on the basis of the extracted feature points exists. This makes it possible to plan a trajectory to avoid the obstacle.

Further, it is only necessary to extract feature points so that a Delaunay mesh can be formed in a region where an object to be recognized as an obstacle on the basis of the extracted feature points exists, and therefore feature points existing on a boundary of the region where the object that can be an obstacle exists may be extracted.

That is, as illustrated in a lower right part of FIG. 11, among the circle marks in the left part of FIG. 11, the feature point extraction unit 76 may extract, as feature points, circle marks existing on each of the following boundaries: boundaries between the road surface R101, the sky C101, and the obstacle B101; boundaries between the road surface R101, the sky C101, and the obstacle B102; and a boundary between the road surface R101 and the sky C101.

More specifically, the feature point extraction unit 76 may extract feature points when at least one of the following conditions is satisfied: a condition in which, as indicated by a region SL around feature points indicated by a dotted line, regarding each circle mark (Lₚ), circle marks adjacent in a horizontal direction and vertical direction indicated by arrows have different semantic labels; a condition in which a difference in depth information (distance information) based on the depth image is larger than a predetermined value; and a condition in which an edge exists between adjacent feature points.

This makes it possible to make the extracted feature points more sparse. Therefore, it is possible to appropriately identify a position of the obstacle while further reducing the processing load.

<Creation of Delaunay Mesh>

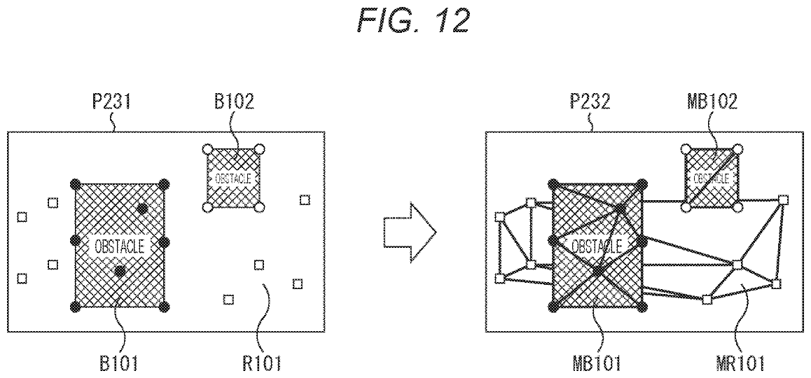

Next, creation of a two-dimensional Delaunay mesh by the Delaunay mesh creation unit 77 will be described with reference to FIG. 12.

The Delaunay mesh creation unit 77 connects the feature points supplied from the feature point extraction unit 76 for each attached semantic label to create a two-dimensional Delaunay mesh having triangular surfaces.

That is, for example, there will be described a case where, as illustrated in an image P231 of FIG. 12, feature points labeled with a semantic label of the obstacle B101 indicated by black circle marks, feature points labeled with a semantic label of the obstacle B102 indicated by white circle marks, and feature points labeled with a semantic label of the road surface R101 indicated by white square marks are extracted as the feature points, respectively.

In such a case, as illustrated in an image P232 of FIG. 12, the Delaunay mesh creation unit 77 connects the feature points labeled with the semantic label of the obstacle B101 indicated by the black circle marks to create a two-dimensional Delaunay mesh MB101.

Further, the Delaunay mesh creation unit 77 connects the feature points labeled with the semantic label of the obstacle B102 indicated by the white circle marks to create a two-dimensional Delaunay mesh MB102.

Further, the Delaunay mesh creation unit 77 connects the feature points labeled with the semantic label of the road surface R101 to create a two-dimensional Delaunay mesh MR101.

That is, in a case of the image P231, the Delaunay mesh creation unit 77 connects the feature points for each same semantic label as illustrated in the image P232 to create a two-dimensional Delaunay mesh in which the Delaunay mesh MB101 of the obstacle B101, the Delaunay mesh MB102 of the obstacle B102, and the Delaunay mesh MR101 of the road surface R101 are combined.

<Three-Dimensionalization of Delaunay Mesh>

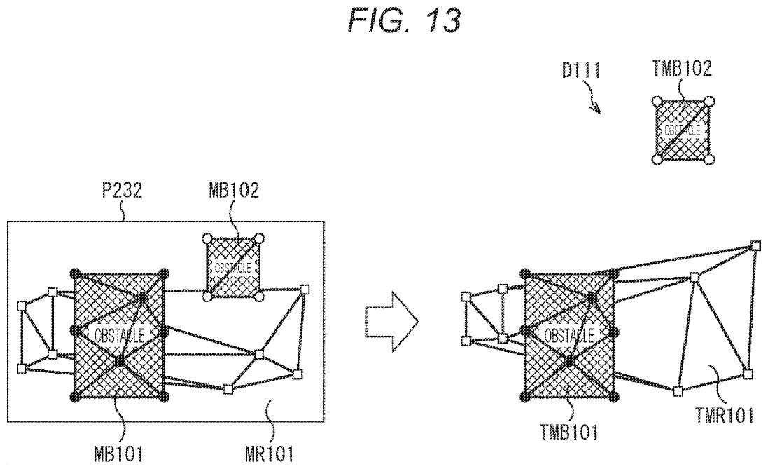

Next, processing in which the mesh three-dimensionalization unit 78 three-dimensionalizes a two-dimensional Delaunay mesh will be described with reference to FIG. 13.

On the basis of the depth information in the depth image (point cloud), the mesh three-dimensionalization unit 78 three-dimensionalizes the two-dimensional Delaunay mesh supplied from the Delaunay mesh creation unit 77 and generates a three-dimensional Delaunay mesh.

For example, there will be described a case of supplying the two-dimensional Delaunay mesh in which the Delaunay mesh MB101 of the obstacle B101, the Delaunay mesh MB102 of the obstacle B102, and the Delaunay mesh MR101 of the road surface R101 corresponding to the image P231 of FIG. 12 are combined as illustrated in a left part of FIG. 13.

In this case, the mesh three-dimensionalization unit 78 uses the depth information (distance information) of each of the feature points of the Delaunay mesh MB101 of the obstacle B101, the Delaunay mesh MB102 of the obstacle B102, and the Delaunay mesh MR101 of the road surface R101 to, for example, arrange the feature points at positions corresponding to the depth information as illustrated in a right part of FIG. 13 and three-dimensionalize the Delaunay meshes, thereby generating a Delaunay mesh D111.

More specifically, in the three-dimensional Delaunay mesh D111, the mesh three-dimensionalization unit 78 three-dimensionalizes the Delaunay mesh MB101 of the obstacle B101 on the basis of the distance information of the feature points, thereby generating a three-dimensional Delaunay mesh TMB101.

Further, the mesh three-dimensionalization unit 78 three-dimensionalizes the Delaunay mesh MB102 of the obstacle B102 on the basis of the distance information of the feature points, thereby generating a three-dimensional Delaunay mesh TMB102.

Furthermore, the mesh three-dimensionalization unit 78 three-dimensionalizes the Delaunay mesh MR101 of the road surface R101 on the basis of the distance information of the feature points, thereby generating a three-dimensional Delaunay mesh TMR101.

As described above, the mesh three-dimensionalization unit 78 three-dimensionalizes the two-dimensional Delaunay mesh MB101 of the obstacle B101, the two-dimensional Delaunay mesh MB102 of the obstacle B102, and the two-dimensional Delaunay mesh MR101 of the road surface R101 and generates and combines the three-dimensional Delaunay mesh TMB101 of the obstacle B101, the three-dimensional Delaunay mesh TMB102 of the obstacle B102, and the three-dimensional Delaunay mesh TMR101 of the road surface R101, thereby generating the three-dimensional Delaunay mesh D111.

Because the three-dimensional Delaunay mesh D111 is generated as described above, no surface is formed by connecting feature points of different obstacles. Therefore, a surface in a Delaunay mesh indicating as if an obstacle exists in a space having no obstacle is not formed. This makes it possible to appropriately recognize positions of the obstacles.

It is possible to recognize the type of obstacle and appropriately recognize a position of the obstacle.

<Action Plan>

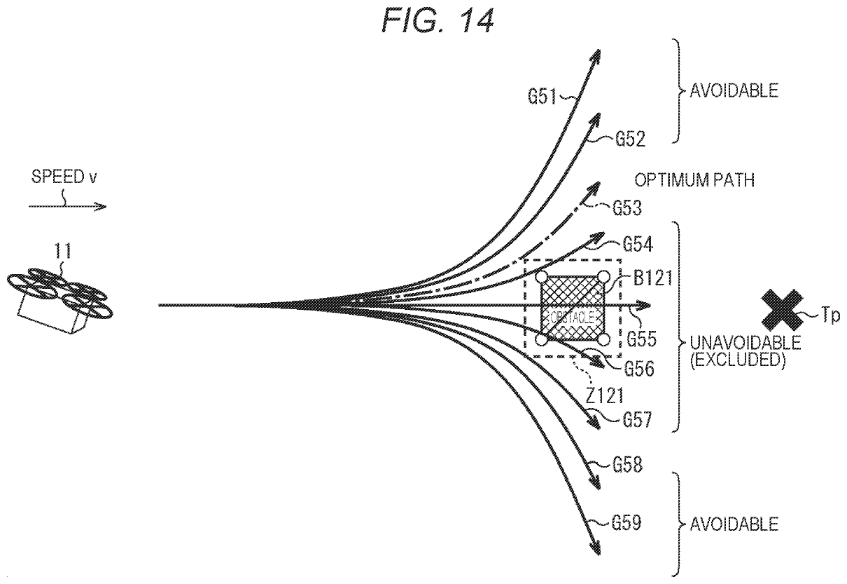

Next, an action plan obtained by the action planning unit 79 planning a trajectory including a movement path of the moving body will be described with reference to FIGS. 14 to 16.

The action planning unit 79 reads a weighting coefficient for a distance set for each semantic label stored in the storage unit 80 and plans a trajectory including an optimum movement path.

More specifically, the action planning unit 79 plans a trajectory that can be planned from a current position to a destination as a trajectory candidate. Then, the action planning unit 79 calculates an evaluation value of each of all the planned trajectory candidates by using an evaluation function and selects a trajectory candidate having the highest evaluation value as an optimum trajectory.

More specifically, first, there will be described a case where the action planning unit 79 plans trajectory candidates G51 to G59 for the moving body 11 at the current position to move to a destination Tp as illustrated in FIG. 14.

The action planning unit 79 first selects trajectory candidates that can avoid an obstacle B121.

In selecting the trajectory candidates that can avoid the obstacle B121, trajectory candidates that can avoid a range around the obstacle B121 surrounded by a dotted line in FIG. 14, the range having a margin for a distance according to the semantic label of the obstacle B121, are selected.

That is, in FIG. 14, the trajectory candidates G51 to G53 and the trajectory candidates G57 to G59 are selected.

Note that the margin is set in accordance with the semantic label of the obstacle B121.

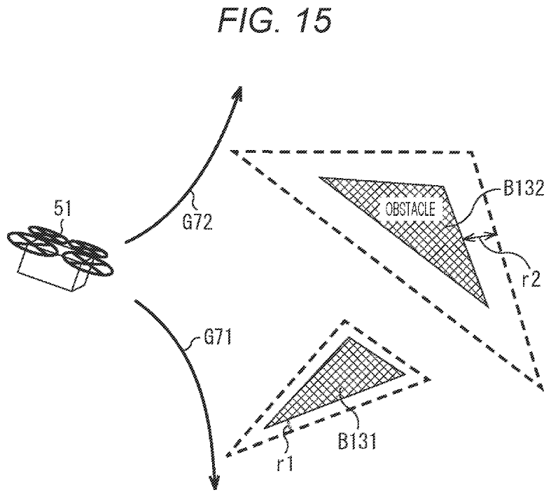

That is, as illustrated in FIG. 15, in a case where an obstacle B131 is labeled with a semantic label that can be accurately recognized in size, such as a tree or building, and is hardly affected even when in contact with the moving body, the action planning unit 79 sets, for example, a distance r1 as the margin and selects a trajectory candidate G71.

Meanwhile, in a case where an obstacle B132 is labeled with a semantic label of, for example, a human, an animal, or a utility pole or the like near which an electric wire or the like may be recognized with an insufficient recognition accuracy from an image captured by a camera and that may be greatly affected when in contact with the moving body, the action planning unit 79 increases the margin, sets, for example, a distance r2 (>r1), and selects a trajectory candidate G72.

By changing the size of the margin in accordance with the semantic label of the obstacle, that is, the type of obstacle as described above, it is possible to select a trajectory candidate including a movement path in consideration of the influence of contact. This makes it possible to plan a trajectory in consideration of safety.

Further, the action planning unit 79 calculates an evaluation value F by using an evaluation function represented by the following Expression (4) based on a heading angle θ, a moving speed v, and a distance d from the obstacle of each of the trajectory candidates G51 to G53 and the trajectory candidates G57 to G59 that can avoid the obstacle.

F=ω_{θ}·E_{θ}+ωv·Eᵥ+ω_{d}·E_{d} (4)

Herein, ω_{θ}, ωᵥ, and ω_{d} denote weights for the heading angle θ, the moving speed v, and the distance d from the obstacle, respectively.

Further, E_{θ} denotes an evaluation function of the heading angle θ that is an angle between a moving direction and a linear direction from the current moving body 11 to the destination. The evaluation value is larger as the angle with respect to the destination is smaller, that is, as the moving body is closer to the destination, whereas the evaluation value is smaller as the moving body is farther from the destination to make a detour.

Eᵥ denotes an evaluation value of the moving speed v. The evaluation value is larger as the moving speed v is faster, whereas the evaluation value is smaller as the moving speed v is slower, that is, as the moving body takes more time to arrive at the destination.

E_{d} denotes an evaluation value of the distance d from the obstacle. The evaluation value is larger as the distance from the obstacle is farther, whereas the evaluation value is smaller as the distance from the obstacle is closer, that is, as a risk of contact is higher.

Herein, the evaluation value E_{d} of the distance d from the obstacle is set to a minimum evaluation value obtained at each sample point on a trajectory and shown by the following Expression (5).

E_{d}=min(α_{S}·dist(S)) (5)

Herein, α_{S} denotes a weight preset in accordance with a semantic label S, dist(S) denotes the shortest distance from each sample point on each trajectory to the obstacle to which the semantic label S is set, and, when a value of a product of as and dist(S) is evaluated for the semantic label S, min denotes output of a minimum value thereof. Finally, a trajectory farther from the obstacle of the semantic label S tends to be selected as the preset weight as set in accordance with the semantic label S is smaller.

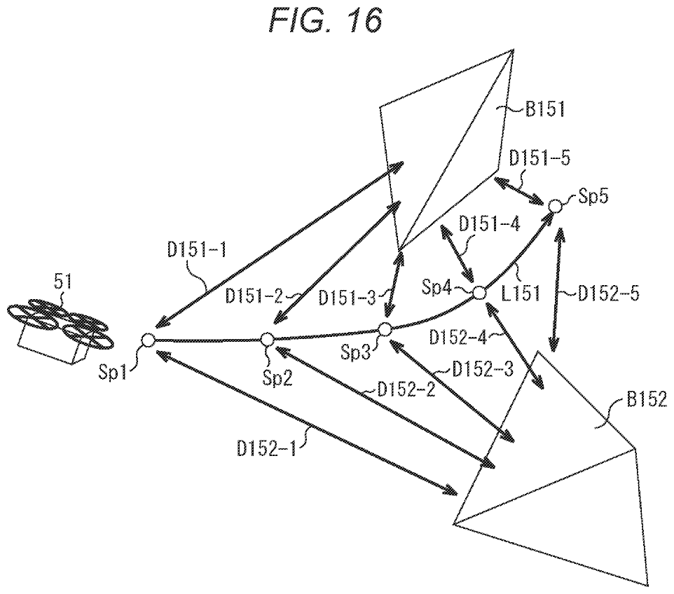

More specifically, as illustrated in FIG. 16, in a case where obstacles B151 and B152 exist, a trajectory L151 is planned, and sample points Sp1 to Sp5 are set on the trajectory, the shortest distances from the sample points Sp1 to Sp5 to the obstacles B151 and B152 are obtained as distances D151-1 to D151-5 and distances D152-1 to D152-5.

Herein, the shortest distance from the obstacle B151 is the distance D151-5, and the shortest distance from the obstacle B152 is the distance D152-4.

Therefore, in a case where a semantic label of the obstacle B151 is LB151, an evaluation value E_{d_B151} of the obstacle B151 for the trajectory L151 of FIG. 16 is α_{LB151}·dist(LB151)= L_{B151}×distance D151-5. Herein, α_{LB151} denotes a weight preset in accordance with the semantic label LB151.

Further, in a case where a semantic label of the obstacle B152 is LB152, the evaluation value E_{d_B152} of the obstacle B152 for the trajectory L151 of FIG. 16 is α_{LB152}·dist(LB152)=α_{LB152}×distance D152-4. Herein, α_{LB152} denotes a weight preset in accordance with the semantic label LB152.

Therefore, the evaluation value E_{d} of the trajectory L151 of FIG. 16 is obtained on the basis of the evaluation value E_{d_B151} and the evaluation value E_{d_B152}, and is set to, for example, a minimum value min(E_{d_B151}, E_{d_B152}) of the evaluation value E_{d_B151} and the evaluation value E_{d_B152}. Further, an average value may be used instead of the minimum value.

That is, the action planning unit 79 selects a trajectory candidate having a maximum evaluation value F calculated from the evaluation function of Expression (4) as a trajectory from among trajectories that can avoid obstacles.

FIG. 14 illustrates an example where the evaluation value F of each of the trajectory candidates G51 to G53 and the trajectory candidates G57 to G59 that can avoid the obstacle is calculated from the evaluation function, a trajectory candidate having the maximum evaluation value F is selected as a trajectory, and, for example, the trajectory candidate G53 indicated by an alternate long and short dashed line has the maximum evaluation value and is selected as the trajectory.

<Trajectory Planning Processing by Trajectory Planning Unit of FIG. 8>

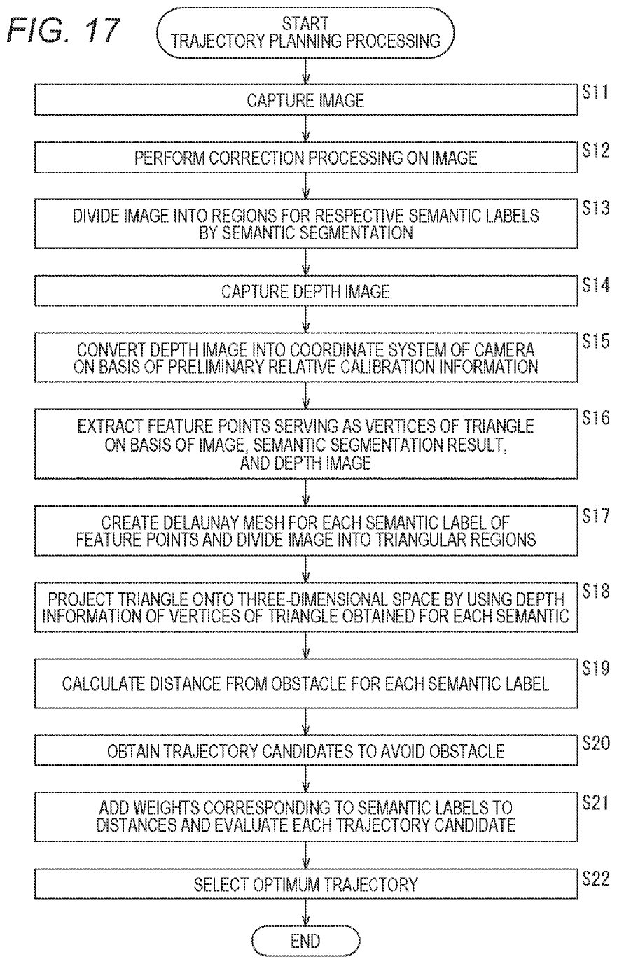

Next, the trajectory planning processing by the trajectory planning unit of FIG. 8 will be described with reference to a flowchart of FIG. 17.

In step S11, the camera 32 captures an image and outputs the image to the image correction processing unit 71.

In step S12, the image correction processing unit 71 performs general image correction processing such as removal of distortion caused by a lens included in the camera 32, demosaic processing, and gamma correction processing on the image captured by the camera 32 and outputs the corrected image to the semantic segmentation processing unit 72 and the feature point extraction unit 76.

In step S13, the semantic segmentation processing unit 72 classifies types of subjects on a pixel basis by semantic segmentation on the basis of the RGB image captured by the camera 32 by using a learned neural network stored by learning in advance in the storage unit 73, divides the image into regions in accordance with semantic labels corresponding to classification results, and outputs a processing result of the semantic segmentation to the feature point extraction unit 76.

In step S14, the depth sensor 33 detects a depth image (point cloud) within a range including an image capturing range of the camera 32 and outputs the depth image to the position correction processing unit 74.

In step S15, the position correction processing unit 74 converts a coordinate system of the depth image (point cloud) supplied from the depth sensor 33 into a coordinate system of the image captured by the camera 32 by position correction on the basis of camera/depth sensor relative position calibration information stored in advance in the storage unit 75, generates a depth image (point cloud) having a coordinate system corresponding to the image captured by the camera 32, and outputs the generated depth image to the feature point extraction unit 76 and the mesh three-dimensionalization unit 78.

In step S16, the feature point extraction unit 76 extracts feature points serving as vertices of triangles forming a Delaunay mesh on the basis of the RGB image supplied from the image correction processing unit 71, the processing result of the semantic segmentation (region division result of the semantic labels) supplied from the semantic segmentation processing unit 72, and the depth image (point cloud) superimposed on the RGB image and outputs the extracted feature points to the Delaunay mesh creation unit 77.

At this time, the feature point extraction unit 76 attaches a corresponding semantic label to each feature point. The feature points are pixels at pixel positions at which the depth information (distance information) is superimposed on the RGB image.

In step S17, the Delaunay mesh creation unit 77 divides the feature points into triangular surfaces having the feature points as vertices for each same semantic label on the basis of the feature points supplied from the feature point extraction unit 76, creates a two-dimensional Delaunay mesh in the image, and outputs the two-dimensional Delaunay mesh to the mesh three-dimensionalization unit 78.

In step S18, the mesh three-dimensionalization unit 78 three-dimensionalizes the two-dimensional Delaunay mesh on the basis of the two-dimensional Delaunay mesh supplied from the Delaunay mesh creation unit 77 and the depth image (point cloud) supplied from the position correction processing unit 74 and outputs a three-dimensional Delaunay mesh to the action planning unit 79.

In step S19, the action planning unit 79 calculates a distance from an obstacle for each semantic label on the basis of the three-dimensional Delaunay mesh. At this time, the distance from the obstacle is calculated to include a margin according to the semantic label.

In step S20, the action planning unit 79 plans a plurality of trajectory candidates toward a destination.

In step S21, the action planning unit 79 adds weights corresponding to the semantic labels, calculates an evaluation value of each trajectory candidate by using an evaluation function, and evaluates the trajectory candidate.

In step S22, the action planning unit 79 selects a trajectory candidate having the highest evaluation value from among the trajectory candidates and outputs the selected trajectory candidate to the operation control unit 52 as an optimum trajectory.

By the above processing, a Delaunay mesh is formed for each semantic label and is further three-dimensionalized on the basis of the depth image (point cloud). This makes it possible to appropriately grasp a position of the obstacle.

This prevents a mesh from being formed as if an obstacle exists, although there is no obstacle in a region. Therefore, it is possible to prevent generation of an unnecessary detour trajectory that avoids a space having no obstacle.

Further, it is possible to set a margin according to a distance from the obstacle in accordance with semantics. This makes it possible to plan a trajectory separated by an appropriate distance according to the type of obstacle. Therefore, it is possible to plan an appropriate trajectory while ensuring safety.

Further, it is possible to obtain an evaluation value of each trajectory candidate according to the heading angle, the moving speed, and the distance from the obstacle on the basis of the evaluation function and select an optimum trajectory on the basis of the obtained evaluation value.

Note that, hereinabove, an example where an obstacle is represented by a Delaunay mesh by using feature points has been described. However, a mesh may be formed by a method other than the Delaunay mesh because it is only necessary to represent an obstacle by using feature points.

### 3. Second Embodiment

Hereinabove, there has been described an example where a three-dimensional Delaunay mesh is generated by using an RGB image captured by the camera 32 and a depth image (point cloud) detected by the depth sensor 33 to appropriately recognize a position of an obstacle and plan a trajectory.

However, a depth image (point cloud) may be acquired to plan a trajectory by providing another camera, i.e., by using a stereo camera including two cameras in total instead of the depth sensor 33.

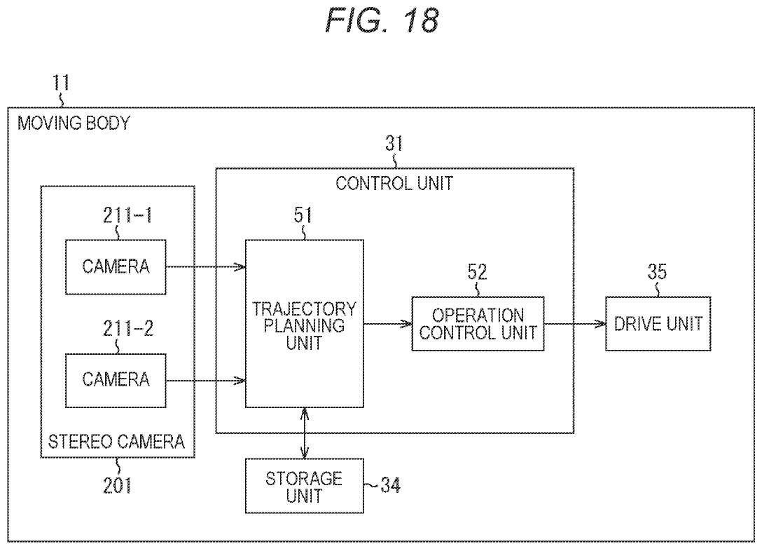

FIG. 18 illustrates a configuration example of the moving body 11 in which another camera is provided instead of the depth sensor 33, i.e., a stereo camera including two cameras in total is used to plan a trajectory.

Note that, in the moving body 11 of FIG. 18, the same configurations having the same functions as those in the moving body 11 of FIG. 7 are denoted by the same reference signs, and description thereof will be omitted as appropriate.

That is, the moving body 11 of FIG. 18 is different from the moving body 11 of FIG. 7 in that a stereo camera 201 is provided instead of the camera 32 and the depth sensor 33.

The stereo camera 201 includes cameras 211-1 and 211-2 provided to generate parallax, each of which captures an image and outputs the image to the trajectory planning unit 51.

The cameras 211-1 and 211-2 are both cameras having the same functions as the camera 32.

The images captured by the cameras 211-1 and 211-2 are mutually regarded as parallax images, and the trajectory planning unit 51 uses the parallax to form a depth image corresponding to the depth image (point cloud) acquired by the depth sensor 33 described above.

Therefore, basically, a three-dimensional Delaunay mesh is formed and a trajectory is planned by similar processing to that of the moving body 11 of FIG. 7 by using one of the images of the cameras 211-1 and 211-2 as a reference and using the depth image (point cloud) obtained from the two images.

<Configuration Example of Trajectory Planning Unit in Moving Body of FIG. 18>

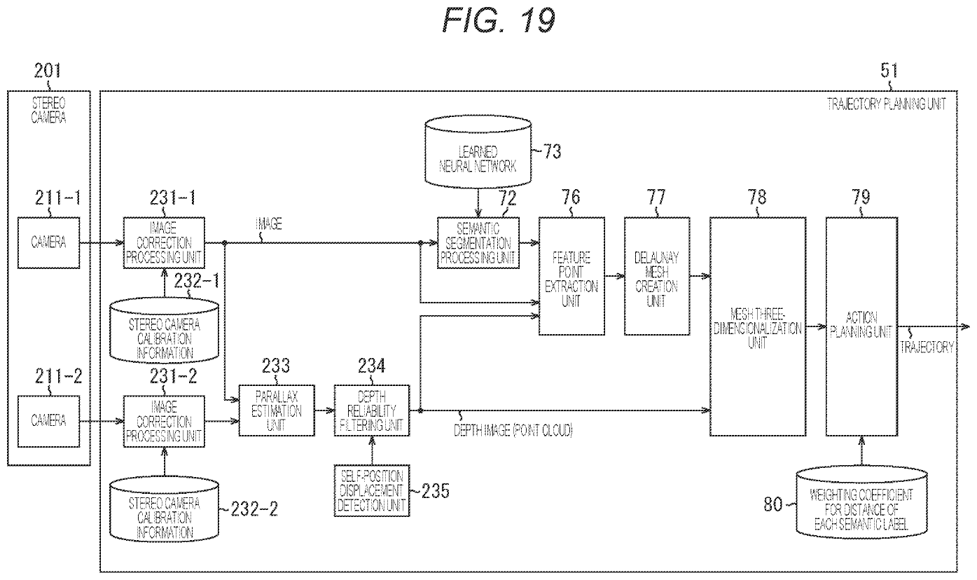

Next, a configuration example of the trajectory planning unit 51 in the moving body 11 of FIG. 18 will be described with reference to FIG. 19.

Note that, in the trajectory planning unit 51 of FIG. 19, configurations having the same functions as those in the trajectory planning unit 51 of FIG. 8 are denoted by the same reference signs, and description thereof will be omitted as appropriate.

The trajectory planning unit 51 of FIG. 19 is different from the trajectory planning unit 51 of FIG. 8 in that image correction processing units 231-1 and 231-2, storage units 232-1 and 232-2, a parallax estimation unit 233, and a depth reliability filtering unit 234 are provided instead of the image correction processing unit 71, the position correction processing unit 74, and the storage unit 75.

The image correction processing units 231-1 and 231-2 perform general image correction processing such as removal of distortion caused by lenses included in the respective cameras 211-1 and 211-2, demosaic processing, and gamma correction processing on images captured by the respective cameras 211-1 and 211-2.

Further, the image correction processing units 231-1 and 231-2 correct the images on the basis of stereo camera calibration information for correcting a relative positional relationship in the images captured by the cameras 211-1 and 211-2 having the parallax, the stereo camera calibration information being stored in advance in the storage units 232-1 and 232-2.

Further, the image correction processing unit 231-1 outputs the corrected image to the semantic segmentation processing unit 72 and the feature point extraction unit 76 and also outputs the corrected image to the parallax estimation unit 233.

The image correction processing unit 231-2 outputs the corrected image to the parallax estimation unit 233.

Note that FIG. 19 illustrates a configuration example where a reference image corresponding to the camera 32 in the trajectory planning unit 51 of FIG. 8 is an image captured by the camera 211-1 in the trajectory planning unit 51. However, an image captured by the camera 211-2 may be used as a reference.

The parallax estimation unit 233 estimates parallax of the two right and left images supplied from the image correction processing units 231-1 and 231-2, generates a depth image (point cloud), and outputs the depth image to the depth reliability filtering unit 234.

More specifically, the parallax estimation unit 233 obtains parallax (displacement of pixels) of the image supplied from the image correction processing unit 231-2 with reference to the image supplied from the image correction processing unit 231-1 by pattern matching or the like and generates a depth image on the basis of the obtained parallax.

The depth reliability filtering unit 234 stores the depth image (point cloud) supplied from the parallax estimation unit 233 and projects a current depth image as a past depth image on the basis of displacement of a self position from a timing at which the past depth image has been acquired, obtains a depth difference that is a difference in depth information from the past depth image on a pixel basis, and obtains reliability of the depth information on a pixel basis on the basis of the depth difference.

Then, the depth reliability filtering unit 234 filters the depth information to be output to the subsequent stage on the basis of the reliability obtained for each pixel, generates a depth image (point cloud) having only reliable depth information, and outputs the depth image to the feature point extraction unit 76 and the mesh three-dimensionalization unit 78.

It is known that depth information obtained by the stereo camera 201 generally has higher environmental dependence than the depth sensor 33 using the LiDAR or the like and many errors occur due to wrong matching.

Therefore, if the depth information is used as it is to create a Delaunay mesh, temporal variation of the Delaunay mesh may increase due to an influence of the errors caused by the wrong matching, which may adversely affect a trajectory plan.

In view of this, herein, the reliability of the depth information is evaluated, and unreliable depth information is filtered (removed).

Hereinabove, an example of using the depth difference as an index of reliability filtering has been described. However, indexes other than the above index may be used, and, for example, a matching error at the time of stereo matching may be used.

Further, it is known that, in an input image for parallax estimation, depth information has high accuracy in a range in which texture or an edge exists. Therefore, a texture or edge strength may be used as the index of the reliability filtering.

Furthermore, a spatial distribution using a median filter or the like or temporal stability may be used as the index of the reliability filtering.

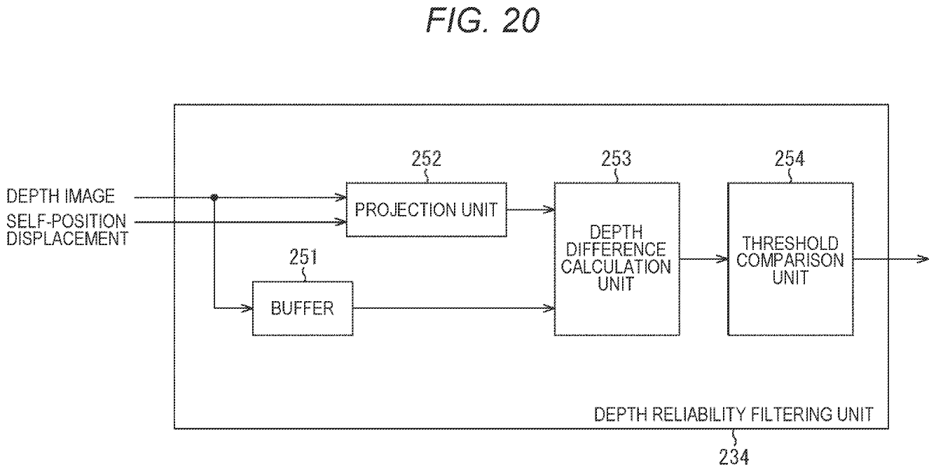

Note that a detailed configuration of the depth reliability filtering unit 234 will be described later in detail with reference to FIG. 20.

A self-position displacement detection unit 235 includes, for example, a motion sensor or the like, detects displacement of a self position between a timing at which a past depth image had been acquired and a timing at which a current depth image has been acquired, and outputs the detected displacement to the depth reliability filtering unit 234.

<Configuration Example of Depth Reliability Filtering Unit>

Next, a configuration example of the depth reliability filtering unit 234 will be described with reference to FIG. 20.

The depth reliability filtering unit 234 includes a buffer 251, a projection unit 252, a depth difference calculation unit 253, and a threshold comparison unit 254.

The buffer 251 stores a supplied depth image and overwrites and stores a supplied depth image each time when a new depth image is supplied. At this time, immediately before overwriting and storing a new depth image, the buffer 251 outputs a previously stored depth image to the depth difference calculation unit 253. Note that, regarding whether to update the image of the buffer 251, the image of the buffer 251 may be updated only when a certain distance or angle changes by using self-position displacement information.

When the new depth image is supplied, the projection unit 252 acquires self-position displacement information from a timing at which the previous depth image has been supplied to the present, projects a current depth image as a depth image at a self position at a timing at which the past depth image has been supplied on the basis of the self-position displacement information, and outputs the depth image together with the acquired current depth image to the depth difference calculation unit 253.

The depth difference calculation unit 253 calculates a depth difference that is a difference in depth information on a pixel basis between the past depth image acquired immediately before the new depth image is supplied from the buffer 251 and the current depth image projected as a depth image at a past timing on the basis of the self-position displacement information and outputs the depth difference together with the acquired current depth image to the threshold comparison unit 254.

The threshold comparison unit 254 compares the depth difference and a threshold on a pixel basis, filters unreliable depth information having a depth difference larger than the threshold, and outputs only a depth image (point cloud) having reliable depth information having a depth difference smaller than the threshold to the feature point extraction unit 76 and the mesh three-dimensionalization unit 78.

Note that the depth image estimated by the parallax estimation unit 233 is generated to have depth information more densely than a depth image generated by the depth sensor including the LiDAR or the like, and therefore, in a case of low-density depth information obtained by the LiDAR or the like, the depth information can be used as feature points as it is, but, when all the depth information is used, there may be too many feature points.

In view of this, the threshold comparison unit 254 of the depth reliability filtering unit 234 may set, for example, the threshold of the depth difference to a value close to 0 to increase a thinning ratio so that only depth information of particularly reliable pixels is used as it is as feature points.

<Trajectory Planning Processing by Trajectory Planning Unit of FIG. 19>

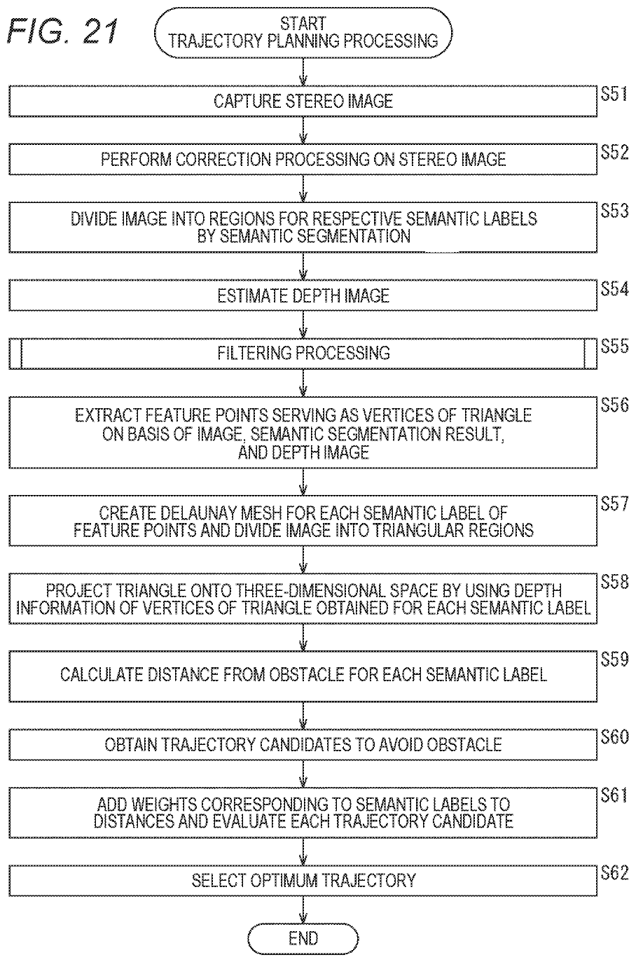

Next, the trajectory planning processing by the trajectory planning unit of FIG. 19 will be described with reference to a flowchart of FIG. 21.

Note that processing in steps S56 to S62 in the flowchart of FIG. 21 is similar to the processing in steps S16 to S22 of FIG. 17, and therefore description thereof will be omitted.

Specifically, in step S51, both the cameras 211-1 and 211-2 of the stereo camera 201 capture images and output the images to the image correction processing units 231-1 and 231-2, respectively.

In step S52, the image correction processing units 231-1 and 231-2 perform general image correction processing such as removal of distortion caused by lenses included in the cameras 211-1 and 211-2, demosaic processing, and gamma correction processing on the images captured by the respective cameras 211-1 and 211-2.

Further, the image correction processing units 231-1 and 231-2 perform processing on the basis of stereo camera calibration information stored in the respective storage units 232-1 and 232-2.

Then, the image correction processing unit 231-1 outputs the processed image to the semantic segmentation processing unit 72, the feature point extraction unit 76, and the parallax estimation unit 233.

Further, the image correction processing unit 231-2 outputs the processed image to the parallax estimation unit 233.

In step S53, the semantic segmentation processing unit 72 classifies types of subjects on a pixel basis by semantic segmentation on the basis of the RGB image captured by the camera 211-1 by using a learned neural network stored by learning in advance in the storage unit 73, divides the image into regions in accordance with semantic labels corresponding to classification results, and outputs a processing result of the semantic segmentation to the feature point extraction unit 76.

In step S54, the parallax estimation unit 233 obtains depth information on the basis of parallax from a reference pixel by performing pattern matching or the like on the image supplied from the image correction processing unit 231-2 with reference to the image supplied from the image correction processing unit 231-1, generates a depth image (point cloud), and outputs the depth image to the depth reliability filtering unit 234.

In step S55, the depth reliability filtering unit 234 executes filtering processing to filter the depth information on the basis of reliability of each piece of the depth information in the depth image (point cloud), generates a depth image (point cloud) only having reliable depth information, and outputs the depth image to the feature point extraction unit 76 and the mesh three-dimensionalization unit 78.

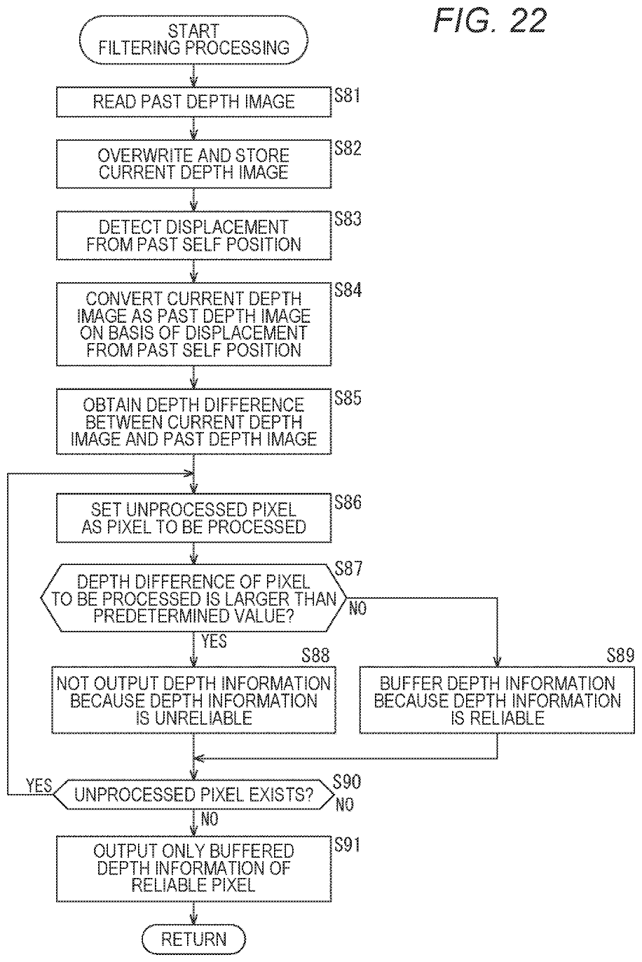

Note that details of the filtering processing will be described later with reference to a flowchart of FIG. 22.

By the above series of processing, it is possible to appropriately plan a trajectory including a movement path of the moving body 11 by using the stereo camera 201, instead of the camera 32 and the depth sensor 33.

<Filtering Processing>

Next, the filtering processing by the depth reliability filtering unit 234 will be described with reference to the flowchart of FIG. 22.

In step S81, the depth difference calculation unit 253 reads a past depth image acquired immediately before buffering in the buffer 251.

In step S82, the buffer 251 acquires a depth image currently supplied from the parallax estimation unit 233, overwrites the depth image on the past depth image, and buffers the depth image.

In step S83, the projection unit 252 acquires, from the self-position displacement detection unit 235, the self-position transition information that is displacement of a self position from a timing at which the past depth image had been acquired to a timing at which the current depth image has been acquired.

In step S84, the projection unit 252 projects the current depth image as a previously acquired depth image on the basis of the self-position displacement information and outputs the depth image together with the current depth image to the depth difference calculation unit 253.

In step S85, the depth difference calculation unit 253 obtains a depth difference that is a difference in depth information between pixels of the past depth image and the current depth image projected as the past depth image on the basis of the self-position transition information and outputs the depth difference together with the current depth image to the threshold comparison unit 254.

In step S86, the threshold comparison unit 254 sets an unprocessed pixel in the current depth image as a pixel to be processed.

In step S87, the threshold comparison unit 254 determines whether or not a depth difference corresponding to the pixel to be processed is larger than a predetermined threshold.

In step S87, in a case where it is determined that the depth difference corresponding to the pixel to be processed is larger than the predetermined threshold, that is, in a case where there is a large change between the previous depth image and the current depth image, the processing proceeds to step S88.

In step S88, because the depth difference is large and a change thereof is large, the threshold comparison unit 254 determines that the depth information corresponding to the pixel to be processed is unreliable and therefore does not output the depth information.

Meanwhile, in step S87, in a case where it is determined that the depth difference corresponding to the pixel to be processed is smaller than the predetermined threshold, that is, in a case where the change between the previous depth image and the current depth image is small, the processing proceeds to step S89.

In step S89, because the depth difference is small and the change thereof is small, the threshold comparison unit 254 determines that the depth information corresponding to the pixel to be processed is reliable and therefore buffers the depth information in association with a pixel position as depth information to be output.

In step S90, the threshold comparison unit 254 determines whether or not an unprocessed pixel exists in the current depth image, and, if an unprocessed pixel exists, the processing returns to step S86.

That is, the processing in steps S86 to S90 is repeated until it is determined that no unprocessed pixel exists, and the reliability of all the pixels in the current depth image is determined on the basis of comparison between the depth difference and the threshold, and only reliable depth information is buffered.

Then, in a case where it is determined in step S90 that no unprocessed pixel exists, the processing proceeds to step S91.

In step S91, the threshold comparison unit 254 outputs a depth image (point cloud) having the buffered depth information that has been determined to be reliable to the feature point extraction unit 76 and the mesh three-dimensionalization unit 78.

By the above processing, it is possible to obtain a depth difference between a current depth image projected as a past depth image based on displacement of a self position and a buffered past depth image, filter (remove) current depth information having a depth difference larger than the threshold as unreliable depth information, and output a depth image (point cloud) only having reliable depth information whose depth difference is smaller than the threshold.

As a result, it is possible to restrain reliability of a depth image (point cloud) acquired by using a stereo camera from being reduced and therefore to achieve an appropriate trajectory plan by using an inexpensive stereo camera, instead of using expensive LiDAR or the like.

### 4. Third Embodiment

Hereinabove, an example of making a trajectory plan using the stereo camera 201 instead of the camera 32 and the depth sensor 33 has been described. However, of the camera 32 and the depth sensor 33, the camera 32 may be replaced with a polarization camera to capture a polarized image, recognize normal directions on an image capturing surface, and extract adjacent feature points having different normal directions.

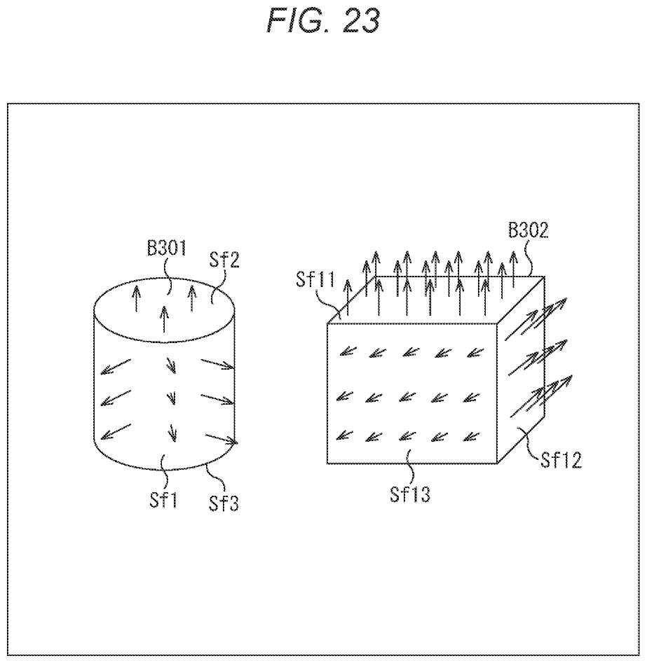

For example, as illustrated in FIG. 23, when images of a columnar obstacle B301 and a rectangular obstacle B302 are captured by the polarization camera, normal directions can be detected by predetermined processing as indicated by arrows.

As a result, only feature points that satisfy at least one of the following conditions may be selectively extracted: a condition in which adjacent feature points have different semantic labels, a condition in which a difference in distance between adjacent feature points is larger than a predetermined value, and a condition in which an edge exists between adjacent feature points as illustrated in the lower right part of FIG. 11; and a condition in which adjacent feature points have different normal directions.

This makes it possible to, in a case of the columnar obstacle B301, extract feature points in the vicinity of a boundary between a curved side surface Sf1 and a disk surface Sf2 of an upper base and a boundary between the curved side surface Sf1 and a disk surface Sf3 of a lower base.

Further, it is possible to, in a case of the rectangular obstacle B302, extract feature points in the vicinity of boundaries between flat surfaces Sf11 to Sf13.

As a result, it is possible to effectively extract only feature points at positions at which a distance or shape changes and form a three-dimensional Delaunay mesh. This makes it possible to form a Delaunay mesh in which a position and shape of an obstacle are appropriately reflected. Therefore, it is possible to appropriately plan a trajectory including a movement path of the moving body so as to avoid obstacles.

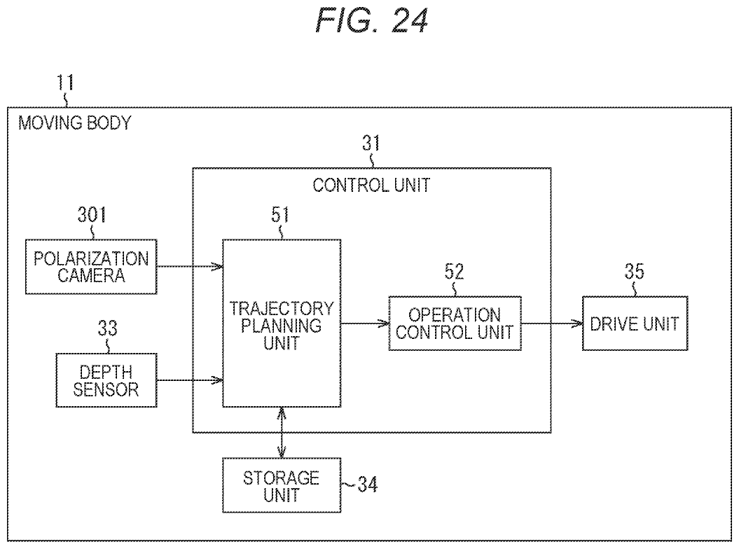

FIG. 24 illustrates a configuration example of the moving body 11 in which a polarized image is captured, normal directions on an image capturing surface are recognized, and feature points at positions at which the normal directions change are extracted.

In the moving body 11 of FIG. 24, the configurations having the same functions as those in the moving body 11 of FIG. 7 are denoted by the same reference signs, and description thereof will be omitted as appropriate.

That is, the configuration of the moving body 11 of FIG. 24 is different from that of the moving body 11 of FIG. 7 in that a polarization camera 301 is provided instead of the camera 32.

The polarization camera 301 includes a polarization lens, captures a polarized image obtained by performing polarization processing on an image captured by the camera 32, and outputs the polarized image to the trajectory planning unit 51.

<Configuration Example of Trajectory Planning Unit Using Polarized Image>

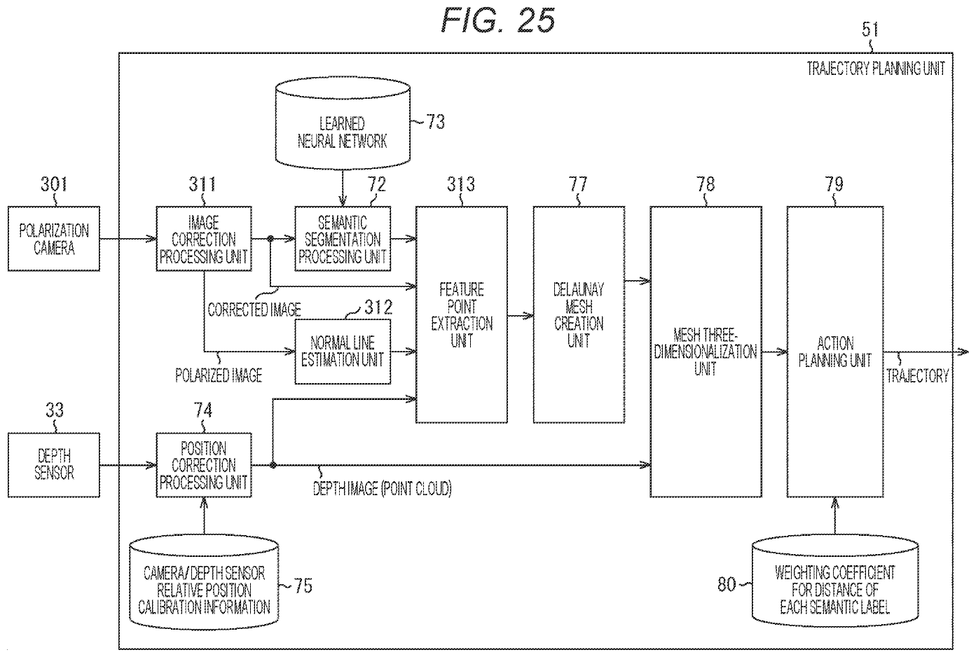

Next, a configuration example of the trajectory planning unit 51 using a polarized image will be described with reference to FIG. 25.

Note that, in the trajectory planning unit 51 of FIG. 25, configurations having the same functions as those in the trajectory planning unit 51 of FIG. 8 are denoted by the same reference signs, and description thereof will be omitted as appropriate.

That is, the trajectory planning unit 51 of FIG. 25 is different from the trajectory planning unit 51 of FIG. 8 in that: an image correction processing unit 311 is provided instead of the image correction processing unit 71 and the feature point extraction unit 76; and a normal line estimation unit 312 that estimates a normal direction of a subject surface in an image on the basis of a polarized image and a feature point extraction unit 313 are provided.

The image correction processing unit 311 is the same as the image correction processing unit 71 in a basic function, but further outputs the polarized image to the normal line estimation unit 312.

The normal line estimation unit 312 estimates a normal direction of a subject surface on the basis of the polarized image supplied from the image correction processing unit 311 and outputs the estimated normal direction to the feature point extraction unit 313.

The feature point extraction unit 313 is similar to the feature point extraction unit 76 in a basic function, but extracts feature points that satisfy at least one of the following conditions: a condition in which adjacent feature points have different semantic labels; a condition in which a difference in distance between adjacent feature points is larger than a predetermined value; a condition in which an edge exists between adjacent feature points; and a condition in which adjacent feature points have different normal directions.

With such a configuration, feature points existing in a region where normal directions change are extracted.

<Trajectory Planning Processing by Trajectory Planning Unit of FIG. 25>

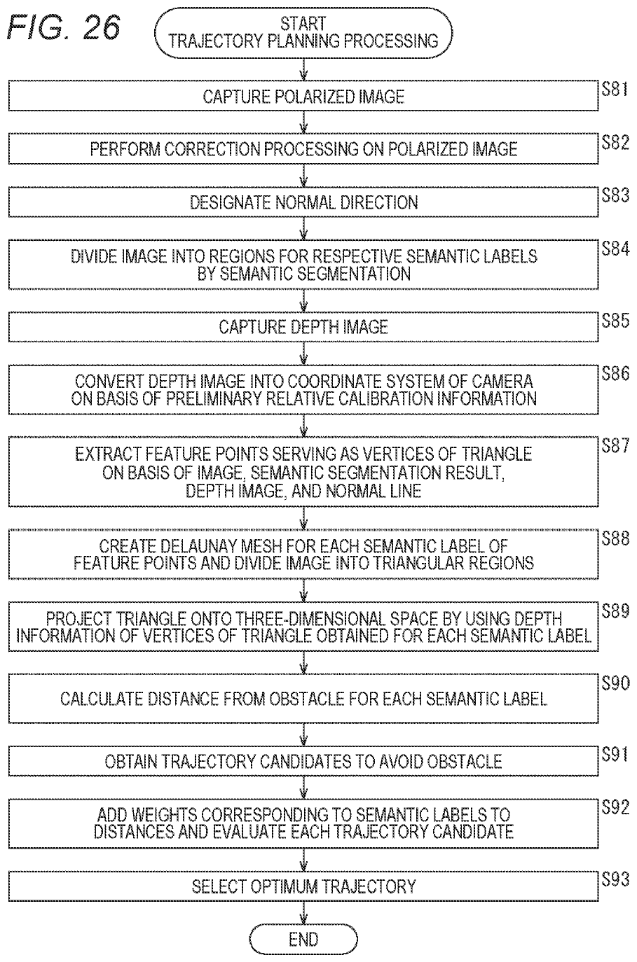

Next, the trajectory planning processing by the trajectory planning unit of FIG. 25 will be described with reference to a flowchart of FIG. 26.

Note that processing in steps S88 to S93 in the flowchart of FIG. 26 is similar to the processing in steps S17 to S22 in the flowchart of FIG. 17, and therefore description thereof will be omitted.

That is, in step S81, the polarization camera 301 captures a polarized image and outputs the polarized image to the image correction processing unit 311.

In step S82, the image correction processing unit 311 performs general image correction such as removal of distortion caused by a lens included in the polarization camera 301, demosaic processing, and gamma correction processing on the polarized image captured by the polarization camera 301 and outputs the corrected image to the semantic segmentation processing unit 72 and the feature point extraction unit 313 and also outputs the polarized image to the normal line estimation unit 312.

In step S83, the normal line estimation unit 312 estimates a normal direction of a subject surface in the image on the basis of the polarized image captured by the polarization camera 301 and outputs an estimation result to the feature point extraction unit 313.

In step S84, the semantic segmentation processing unit 72 classifies types of subjects on a pixel basis by semantic segmentation on the basis of the RGB image captured by the camera 32 by using a learned neural network stored by learning in advance in the storage unit 73, divides the image into regions in accordance with semantic labels corresponding to classification results, and outputs a processing result of the semantic segmentation to the feature point extraction unit 313.

In step S85, the depth sensor 33 detects a depth image (point cloud) within a range including an image capturing range of the polarization camera 301 and outputs the depth image to the position correction processing unit 74.

In step S86, the position correction processing unit 74 converts a coordinate system of the depth image (point cloud) supplied from the depth sensor 33 into a coordinate system of the image captured by the camera 32 by position correction on the basis of camera/depth sensor relative position calibration information stored in advance in the storage unit 75, generates a depth image (point cloud) having a coordinate system corresponding to the image captured by the camera 32, and outputs the generated depth image to the feature point extraction unit 313 and the mesh three-dimensionalization unit 78.

In step S87, the feature point extraction unit 313 extracts feature points serving as vertices of triangles forming a Delaunay mesh on the basis of the RGB image supplied from the image correction processing unit 71, the processing result of the semantic segmentation (semantic label) supplied from the semantic segmentation processing unit 72, the point cloud superimposed on the RGB image, and an estimation result of the normal direction and outputs the extracted feature points to the Delaunay mesh creation unit 77.

By the above series of processing, it is possible to effectively extract feature points at positions at which normal directions change, i.e., at which a distance or shape changes. This makes it possible to form a three-dimensional Delaunay mesh in which a position and shape of an obstacle are appropriately reflected. Therefore, it is possible to appropriately plan a trajectory including a movement path of the moving body.

### 5. Example of Execution by Software

By the way, the series of processing described above can be executed by hardware or software. In a case where the series of processing is executed by software, a program forming the software is installed from a recording medium in a computer incorporated in dedicated hardware or, for example, a general-purpose computer or the like that can execute various functions by installing various programs.

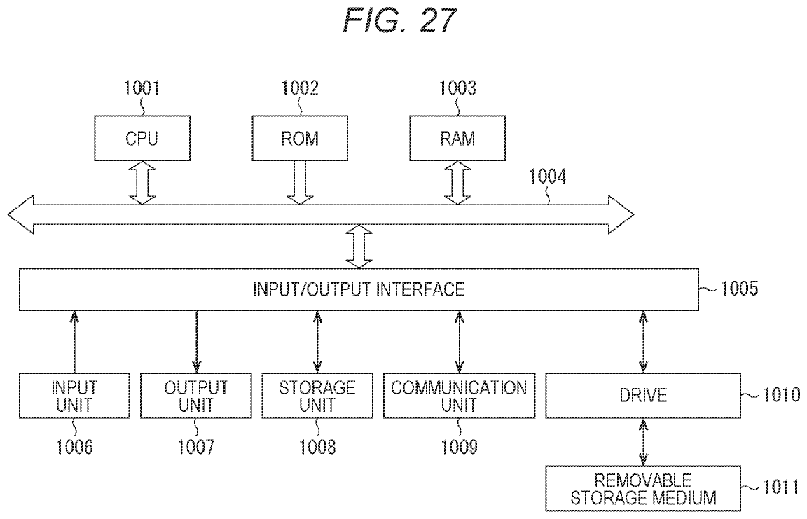

FIG. 27 illustrates a configuration example of a general-purpose computer. This personal computer includes a central processing unit (CPU) 1001. The CPU 1001 is connected to an input/output interface 1005 via a bus 1004. The bus 1004 is connected to a read only memory (ROM) 1002 and a random access memory (RAM) 1003.

The input/output interface 1005 is connected to an input unit 1006 that includes input devices such as a keyboard and a mouse for a user to input an operation command, an output unit 1007 that outputs a processing operation screen and an image of a processing result to a display device, a storage unit 1008 that includes a hard disk drive or the like for storing programs and various kinds of data, and a communication unit 1009 that includes a local area network (LAN) adapter or the like and executes communication processing via a network represented by the Internet. Further, a drive 1010 that reads and writes data is connected to a removable storage medium 1011 such as a magnetic disk (including a flexible disc), an optical disk (including a compact disc-read only memory (CD-ROM) and a digital versatile disc (DVD)), a magneto-optical disk (including a mini disc (MD)), or a semiconductor memory.

The CPU 1001 executes various kinds of processing in accordance with a program stored in the ROM 1002 or a program read from the removable storage medium 1011 such as a magnetic disk, an optical disk, a magneto-optical disk, or a semiconductor memory, installed in the storage unit 1008, and loaded from the storage unit 1008 into the RAM 1003. The RAM 1003 also appropriately stores data and the like necessary for the CPU 1001 to execute various kinds of processing.

In the computer configured as described above, the series of processing described above is performed by, for example, the CPU 1001 loading a program stored in the storage unit 1008 into the RAM 1003 via the input/output interface 1005 and the bus 1004 and executing the program.

The program executed by the computer (CPU 1001) can be provided by, for example, being recorded on the removable storage medium 1011 as a package medium or the like. Further, the program can be provided via a wired or wireless transmission medium such as a local area network, the Internet, or digital satellite broadcasting.

In the computer, the program can be installed in the storage unit 1008 via the input/output interface 1005 by attaching the removable storage medium 1011 to the drive 1010. Further, the program can be received by the communication unit 1009 via the wired or wireless transmission medium and be installed in the storage unit 1008. In addition, the program can also be installed in the ROM 1002 or storage unit 1008 in advance.

Note that the program executed by the computer may be a program in which the processing is performed in time series in the order described in this specification, or may be a program in which the processing is performed in parallel or at a necessary timing such as when a call is made.

Note that the CPU 1001 of FIG. 27 achieves the functions of the control unit 31 of FIGS. 7, 18, and 24.

Further, in this specification, a system means a set of a plurality of components (devices, modules (parts), and the like), and it does not matter whether or not all the components are included in the same housing. Therefore, a plurality of devices included in separate housings and connected via a network and a single device including a plurality of modules in a single housing are both systems.

Note that the embodiments of the present disclosure are not limited to the above embodiments, and can be variously modified without departing from the gist of the present disclosure.

For example, the present disclosure can have a configuration of cloud computing in which a single function is shared and jointly processed by a plurality of devices via a network.

Further, each of the steps described in the above flowcharts can be executed by a single device, or can be executed by being shared by a plurality of devices.

Furthermore, in a case where a single step includes a plurality of processes, the plurality of processes included in the single step can be executed by a single device or can be executed by being shared by a plurality of devices.

Note that the present disclosure can also have the following configurations.

<1> An information processing device including:

an object recognition unit that recognizes an object in an image of surroundings of a moving body;

a feature point extraction unit that extracts feature points from the image in association with an object recognition result by the object recognition unit;

a mesh creation unit that creates a mesh representing an obstacle by connecting the feature points for each same object on the basis of the object recognition result; and

an action planning unit that plans action of the moving body to avoid the obstacle on the basis of the mesh created by the mesh creation unit.

<2> The information processing device according to <1>, in which

the object recognition unit recognizes the object in the image by semantic segmentation, and

the feature point extraction unit extracts the feature points from the image in association with a semantic label serving as the object recognition result using the semantic segmentation.

<3> The information processing device according to <2>, in which

the feature point extraction unit associates the feature points in the vicinity of the object that can be the obstacle with the semantic label and extracts the feature points from the image on the basis of the semantic label.

<4> The information processing device according to <2>, in which

the feature point extraction unit associates pixels of the image corresponding to positions at which depth information exists in a depth image corresponding to the image with the semantic label and extracts the pixels as the feature points.

<5> The information processing device according to <4>, in which

the feature point extraction unit extracts the feature points from the image in association with the semantic label serving as the object recognition result using the semantic segmentation and further selectively extracts, from the extracted feature points, feature points that satisfy at least one of the following conditions in association with the semantic label: a condition in which adjacent feature points have different semantic labels; a condition in which depth information of adjacent feature points is significantly different from a predetermined value; and a condition in which an edge exists between adjacent feature points.

<6> The information processing device according to <4>, in which

the mesh creation unit generates a two-dimensional mesh representing the obstacle by connecting the feature points for each object of the same semantic label on the basis of the object recognition result.

<7> The information processing device according to <6>, further including

a three-dimensionalization unit that three-dimensionalizes the two-dimensional mesh on the basis of the depth information of the depth image and generates a three-dimensional mesh, in which

the action planning unit plans the action of the moving body to avoid the obstacle on the basis of the three-dimensional mesh generated by the three-dimensionalization unit.

<8> The information processing device according to <7>, in which

the action planning unit sets a margin for a distance according to the semantic label to the obstacle represented by the three-dimensional mesh and plans a trajectory for the moving body to act to avoid the obstacle.

<9> The information processing device according to <8>, in which

the action planning unit plans trajectory candidates for acting to avoid the obstacle, calculates evaluation values for evaluating the respective trajectory candidates, and selects the trajectory from the trajectory candidates on the basis of the evaluation values.

<10> The information processing device according to <9>, in which

the action planning unit calculates the evaluation values for evaluating the respective trajectory candidates by using an evaluation function including a term for calculating a direction evaluation value of an angle between a linear direction from the moving body to a destination and a moving direction of the moving body, a term for calculating a speed evaluation value of a moving speed of the moving body, and a term for calculating a distance evaluation value of a distance between the moving body and the obstacle and selects the trajectory from the trajectory candidates on the basis of the evaluation values.

<11> The information processing device according to <10>, in which

a weight is set for each of the direction, speed, and distance evaluation values in the evaluation function, the action planning unit calculates the evaluation values by a sum of products of the direction evaluation value, the speed evaluation value, the distance evaluation value, and the weights of the direction, speed, and distance evaluation values and selects the trajectory candidate having a maximum evaluation value as the trajectory.

<12> The information processing device according to <10>, in which

the weight for the distance according to the semantic label is set in the term for calculating the distance evaluation value.

<13> The information processing device according to any one of <4> to <12>, in which

the depth image is detected by LiDAR.

<14> The information processing device according to any one of <4> to <12>, in which

the depth image is generated on the basis of two images captured by a stereo camera, and

the image is captured by any one of cameras included in the stereo camera.

<15> The information processing device according to <14>, further including

a parallax estimation unit that estimates parallax on the basis of the two images captured by the stereo camera and generates the depth image on the basis of the estimated parallax.

<16> The information processing device according to <15>, further including

a filtering unit that compares a depth difference that is a difference in depth information between time-series depth images of the depth image generated on the basis of the two images captured by the stereo camera with a predetermined threshold to filter the depth information having the depth difference larger than the predetermined threshold.

<17> The information processing device according to <14>, in which

the image is a polarized image captured by a polarization camera,

the information processing device further includes a normal line estimation unit that estimates a normal direction of a surface of an object in the polarized image on the basis of the polarized image, and

the feature point extraction unit extracts the feature points from the image in association with the object recognition result by the object recognition unit and further selectively extracts feature points that satisfy at least one of the following conditions in association with the semantic label: a condition in which adjacent feature points have different semantic labels; a condition in which adjacent feature points have different pieces of depth information; a condition in which an edge exists between adjacent feature points; and a condition in which normal directions at adjacent feature points change.

<18> The information processing device according to any one of <1> to <17>, in which

the mesh creation unit creates a Delaunay mesh representing the obstacle by connecting the feature points to form a triangle having the feature points as vertices for each same object on the basis of the object recognition result.

<19> An information processing method including the steps of:

recognizing an object in an image of surroundings of a moving body;

extracting feature points from the image in association with a recognition result of the object;

creating a mesh representing an obstacle by connecting the feature points for each same object on the basis of the recognition result of the object; and

planning action of the moving body to avoid the obstacle on the basis of the created mesh.

<20> A program for causing a computer to function as:

an object recognition unit that recognizes an object in an image of surroundings of a moving body;

a feature point extraction unit that extracts feature points from the image in association with an object recognition result by the object recognition unit;

a mesh creation unit that creates a mesh representing an obstacle by connecting the feature points for each same object on the basis of the object recognition result; and

an action planning unit that plans action of the moving body to avoid the obstacle on the basis of the mesh created by the mesh creation unit.

### REFERENCE SIGNS LIST

11 Moving body
31 Control unit
32 Camera
33 Depth sensor
34 Storage unit
35 Drive unit
51 Trajectory planning unit
52 Operation control unit
71 Image correction processing unit
72 Semantic segmentation processing unit
73 Storage unit
74 Position correction processing unit
75 Storage unit
76 Feature point extraction unit
77 Delaunay mesh creation unit
78 Mesh three-dimensionalization unit
79 Action planning unit
80 Storage unit
201 Stereo camera
211-1, 211-2 Camera
231-1, 231-2 Image correction processing unit
232-1, 232-2 Storage unit
233 Parallax estimation unit
234 Depth reliability filtering unit
235 Self-position transition detection unit
251 Buffer
252 Projection unit
253 Depth difference calculation unit
254 Threshold comparison unit
301 Polarization camera
311 Image correction processing unit
312 Normal line estimation unit
313 Feature point extraction unit

1. An information processing device comprising:
an object recognition unit that recognizes an object in an image of surroundings of a moving body;
a feature point extraction unit that extracts feature points from the image in association with an object recognition result by the object recognition unit;
a mesh creation unit that creates a mesh representing an obstacle by connecting the feature points for each same object on a basis of the object recognition result; and
an action planning unit that plans action of the moving body to avoid the obstacle on a basis of the mesh created by the mesh creation unit.

2. The information processing device according to claim 1, wherein
the object recognition unit recognizes the object in the image by semantic segmentation, and
the feature point extraction unit extracts the feature points from the image in association with a semantic label serving as the object recognition result using the semantic segmentation.

3. The information processing device according to claim 2, wherein
the feature point extraction unit associates the feature points in the vicinity of the object that can be the obstacle with the semantic label and extracts the feature points from the image on a basis of the semantic label.

4. The information processing device according to claim 2, wherein
the feature point extraction unit associates pixels of the image corresponding to positions at which depth information exists in a depth image corresponding to the image with the semantic label and extracts the pixels as the feature points.

5. The information processing device according to claim 4, wherein
the feature point extraction unit extracts the feature points from the image in association with the semantic label serving as the object recognition result using the semantic segmentation and further selectively extracts, from the extracted feature points, feature points that satisfy at least one of the following conditions in association with the semantic label: a condition in which adjacent feature points have different semantic labels; a condition in which depth information of adjacent feature points is significantly different from a predetermined value; and a condition in which an edge exists between adjacent feature points.

6. The information processing device according to claim 4, wherein
the mesh creation unit generates a two-dimensional mesh representing the obstacle by connecting the feature points for each object of the same semantic label on a basis of the object recognition result.

7. The information processing device according to claim 6, further comprising
a three-dimensionalization unit that three-dimensionalizes the two-dimensional mesh on a basis of the depth information of the depth image and generates a three-dimensional mesh, wherein
the action planning unit plans the action of the moving body to avoid the obstacle on a basis of the three-dimensional mesh generated by the three-dimensionalization unit.

8. The information processing device according to claim 7, wherein
the action planning unit sets a margin for a distance according to the semantic label to the obstacle represented by the three-dimensional mesh and plans a trajectory for the moving body to act to avoid the obstacle.

9. The information processing device according to claim 8, wherein
the action planning unit plans trajectory candidates for acting to avoid the obstacle, calculates evaluation values for evaluating the respective trajectory candidates, and selects the trajectory from the trajectory candidates on a basis of the evaluation values.

10. The information processing device according to claim 9, wherein
the action planning unit calculates the evaluation values for evaluating the respective trajectory candidates by using an evaluation function including a term for calculating a direction evaluation value of an angle between a linear direction from the moving body to a destination and a moving direction of the moving body, a term for calculating a speed evaluation value of a moving speed of the moving body, and a term for calculating a distance evaluation value of a distance between the moving body and the obstacle and selects the trajectory from the trajectory candidates on a basis of the evaluation values.

11. The information processing device according to claim 10, wherein
a weight is set for each of the direction, speed, and distance evaluation values in the evaluation function, the action planning unit calculates the evaluation values by a sum of products of the direction evaluation value, the speed evaluation value, the distance evaluation value, and the weights of the direction, speed, and distance evaluation values and selects the trajectory candidate having a maximum evaluation value as the trajectory.

12. The information processing device according to claim 10, wherein
the weight for the distance according to the semantic label is set in the term for calculating the distance evaluation value.

13. The information processing device according to claim 4, wherein
the depth image is detected by LiDAR.

14. The information processing device according to claim 4, wherein
the depth image is generated on a basis of two images captured by a stereo camera, and
the image is captured by any one of cameras included in the stereo camera.

15. The information processing device according to claim 14, further comprising
a parallax estimation unit that estimates parallax on a basis of the two images captured by the stereo camera and generates the depth image on a basis of the estimated parallax.

16. The information processing device according to claim 15, further comprising
a filtering unit that compares a depth difference that is a difference in depth information between time-series depth images of the depth image generated on a basis of the two images captured by the stereo camera with a predetermined threshold to filter the depth information having the depth difference larger than the predetermined threshold.

17. The information processing device according to claim 14, wherein
the image is a polarized image captured by a polarization camera,
the information processing device further comprises a normal line estimation unit that estimates a normal direction of a surface of an object in the polarized image on a basis of the polarized image, and
the feature point extraction unit extracts the feature points from the image in association with the object recognition result by the object recognition unit and further selectively extracts feature points that satisfy at least one of the following conditions in association with the semantic label: a condition in which adjacent feature points have different semantic labels; a condition in which adjacent feature points have different pieces of depth information; a condition in which an edge exists between adjacent feature points; and a condition in which normal directions at adjacent feature points change.

18. The information processing device according to claim 1, wherein
the mesh creation unit creates a Delaunay mesh representing the obstacle by connecting the feature points to form a triangle having the feature points as vertices for each same object on a basis of the object recognition result.

19. An information processing method comprising the steps of:
recognizing an object in an image of surroundings of a moving body;
extracting feature points from the image in association with a recognition result of the object;
creating a mesh representing an obstacle by connecting the feature points for each same object on a basis of the recognition result of the object; and
planning action of the moving body to avoid the obstacle on a basis of the created mesh.

20. A program for causing a computer to function as:
an object recognition unit that recognizes an object in an image of surroundings of a moving body;
a feature point extraction unit that extracts feature points from the image in association with an object recognition result by the object recognition unit;
a mesh creation unit that creates a mesh representing an obstacle by connecting the feature points for each same object on a basis of the object recognition result; and
an action planning unit that plans action of the moving body to avoid the obstacle on a basis of the mesh created by the mesh creation unit.
